(19) United States
(12) Patent Application Publication
(10) Pub. No.: US 2009/0113830 A1
(43) Pub. Date: May 7, 2009

(54) Composite garage doors and processes for making such doors

(75) Inventors: Randy Clark, Klamath Falls, OR (US); Kenneth D. Kiest, Klamath Falls, OR (US)

Correspondence Address: NELSON MULLINS RILEY & SCARBOROUGH, LLP, 1320 MAIN STREET, 17TH FLOOR, COLUMBIA, SC, 29201, US

(73) Assignee: JELD-WEN, inc., Klamath Falls, OR (US)

(21) Appl. No.: 11/983,091

(22) Filed: Nov. 7, 2007

(51) Int. Cl. E06B 3/72

(52) U.S. Cl. 52/455; 52/745.19

(57) ABSTRACT

Metal doors may be more cost-efficient than wood to manufacture and maintain, but may not be as aesthetically pleasing to the consumer. For example, metal garage doors may only be available in limited color lines and often do not simulate a natural wood grain in a very realistic manner. Also, metal garage doors may be limited in design, in that it may be difficult to add three dimensional shaping, such as trim or paneling, to the outer surface of a metal door. For example, some manufacturers apply extrusive plastic panels to the face of a metal garage door to add a design to the face of the door. The plastic and metal components, however, may exhibit different physical properties in response to changes in temperature and humidity and thus, the door may exhibit warping or other types of deformation upon exposure to weather.

### BACKGROUND OF THE INVENTION

The present invention relates to the manufacture of composite doors, such as composite garage doors. More specifically, the present invention relates to the manufacture of thin-layer lignocellulosic composites, such as wood-composite door skins, for use as garage door skins. The present invention relates to thin-layer wood composites that contain an isocyanate based-resin and thus, exhibit significantly less swelling and/or shrinking upon exposure to the environment.

Doors manufactured from wood have a pleasing appearance and a substantial and solid feel. While the appearance of natural wood is aesthetically pleasing, wood can be susceptible to damage caused by long-term exposure to humid or dry air, weather, fungal infestation, and insect pests. Thus, frequent and often costly maintenance may be required to prevent the deterioration of finished wood that is exposed to the environment. Also, many species of wood having a desirable appearance are also expensive, and require significant labor and time for production of finished articles.

Metal doors may be more cost-effective than wood to manufacture and maintain, but may not be as aesthetically pleasing to the consumer. For example, metal garage doors may only be available in limited color lines and often do not simulate a natural wood grain in a very realistic manner. Also, metal garage doors may be limited in design, in that it may be difficult to add three dimensional shaping, such as trim or paneling, to the outer surface of a metal door. For example, some manufacturers apply extrusive plastic panels to the face of a metal garage door to add a design to the face of the door. The plastic and metal components, however, may exhibit different physical properties in response to changes in temperature and humidity and thus, the door may exhibit warping or other types of deformation upon exposure to weather.

Multi-paneled, roll-up garage doors have become standard in the industry. Many consumers prefer the look of a traditional one piece (lift-up, swing, or sliding) garage door that is typical of Tudor or other types of traditional architecture, but desire the convenience of a multi-panel roll-up garage door. Such single panel garage doors include design features, such as trim and vertical paneling, that utilize the entire face of the garage door to provide and appearance that is distinguishable from the multi-paneled look typical of a roll-up door.

A significant problem in the manufacture of wood-based composite products that are exposed to the exterior and extreme interior environments, such as wood-based composites for garage doors, is that upon exposure to variations in temperature and moisture, the wood can lose water and shrink, or gain water and swell. This tendency to shrink and/or swell can significantly limit the useful lifetime of most exterior wood products, such as wooden doors, often necessitating replacement after only a few years. The problem is particularly prevalent in areas of high moisture (e.g., Hawaii) or in climates that are extremely hot or dry (e.g., Arizona). Shrinking and swelling can also be a problem when the wood is exposed to a wet environment during construction, or upon exposure to dry heat.

A possible solution to the problem of moisture gain and loss in wood exposed to the elements includes covering the wood with paint and/or other coatings that act as a barrier to moisture. Still, such coatings tend to wear off with time, leaving the wood susceptible to the environment.

Rather than treating the garage door at the site of installation, it may be preferable to manufacture products that exhibit increased resistance to moisture gain and loss. For example, increasing the amounts of resin content or decreasing the amount of wood fiber used in a door can increase resistance to water gain and water loss. Such modifications, however, can be associated with significantly increased production costs. Other options include the use of metal or fiberglass doors, but, as discussed above, such doors are not always as aesthetically pleasing as wood doors and may have other performance problems associated with the use of these materials.

Alternatively, doors, and other structural units, may be covered with a wood-containing water-resistant layer. For example, doors may be covered with a thin-layer wood composite known as a doorskin. Doorskins are molded as thin layers to be adhesively secured to an underlying door frame to thereby provide a water-resistant outer surface. Doorskins may be made by mixing wood fiber, optionally, a wax, and a resin binder, and then pressing the mixture under conditions of elevated temperature and pressure to form a thin-layer wood composite that is then bonded to the underlying door frame.

Wood composite doorskins are traditionally formed by pressing wood fragments in the presence of a binder at temperatures exceeding 275° F. (135° C.). The resin binder used in the doorskin may be a formaldehyde-based resin, an isocyanate-based resin, or other thermoplastic or thermoset resins. Formaldehyde-based resins typically used to make wood composite products include phenol-formaldehyde, urea-formaldehyde, or melamine-formaldehyde. Phenol-formaldehyde resins require a high temperature cure and are sensitive to the amount of water in the wood since excess water can inhibit the high temperature cure. Urea and melamine-formaldehyde resins do not require as high of a temperature cure, but traditionally do not provide comparable water-resistance (at the same resin content) in the doorskin product.

Additionally, many states are regulating the use of formaldehyde-based products due to environmental and health concerns related to reported carcinogenic effects of formaldehyde. Accordingly, formaldehyde-based products are losing favor in the market, and in some cases are regulated, and in other cases, banned from the market.

As compared to doorskins made using phenol-formaldehyde resins, typical doorskins that utilize high-temperature pressed isocyanate resin binder display increased surface strength. These typical doorskins, however, exhibit decreased porosity to adhesives and thus, do not bond well to the underlying doorframe. Also, typical isocyanate-bonded wood composites made using currently available methods and compositions do not consistently exhibit sufficient resistance to environmentally-induced swelling and/or shrinking to be commercially useful.

### SUMMARY OF THE INVENTION

The present invention includes composite doors for exterior use, such as for garage doors, and processes for making such doors. The present invention may be embodied in a variety of ways.

In one aspect, an exemplary embodiment of the invention is a method to produce a thin-layer lignocellulosic composite having increased resistance to moisture-induced shrinking or swelling. The method includes forming a lignocellulosic composite mixture comprising (1) at least one type of lignocellulosic fiber having a moisture content of at least about 3% by weight and (2) at least 5% by weight of an organic isocyanate resin, a release agent that migrates to the surface of the thin-layer lignocellulosic composite during pressing, and, optionally, a wax. The method further includes pre-pressing the mixture into a loose mat and pressing the mat between two dies at an elevated temperature and pressure and for a sufficient time to further reduce the thickness of the mat to form a thin-layer composite having a thickness of between about 1 and about 3 mm. The pressing step further allows the isocyanate resin to interact with the lignocellulosic fiber such that the resultant thin-layer composite has a predetermined resistance to moisture, wherein the thin-layer lignocellulosic composite comprises a molded door skin suitable for exterior use, and wherein at least one surface of at least one die is coated with an anti-bonding agent.

In another aspect, an exemplary embodiment of the invention is a thin-layer lignocellulosic composite comprising a mixture of no more than 95% by weight of at least one type of lignocellulosic fiber having a moisture content of at least about 3% by weight, at least 5% by weight of an organic isocyanate resin, optionally, a wax, and an internal release agent distinct from the wax, wherein the mixture is pressed between two dies at an elevated temperature and pressure and for a sufficient time to form a thin-layer composite of predetermined thickness, and to allow the isocyanate resin to interact with the lignocellulosic fiber such that the resultant thin-layer composite has a predetermined resistance to moisture.

In yet another aspect, an exemplary embodiment of the invention is a garage door panel comprising a panel having a region of increased thickness to provide at least one raised surface, such that the raised surface comprises the appearance of at least one of wooden planking or wooden trim, the panel further comprising a mixture of no more than 95% by weight of at least one type of lignocellulosic fiber having a moisture content of at least about 3% by weight, at least 5% by weight of an organic isocyanate resin, optionally, a wax, and an internal release agent distinct from the wax, wherein the mixture is pressed between two dies at an elevated temperature and pressure and for a sufficient time to form a thin-layer composite of predetermined thickness, and to allow the isocyanate resin to interact with the lignocellulosic fiber such that the resultant thin-layer composite has a predetermined resistance to moisture. The panel further comprises a frame having at least two vertical stiles and two horizontal rails and a core material emplaced within, and bounded by, the frame.

These and other aspects and embodiments of the invention will be understood and become apparent upon review of the specification by those having ordinary skill in the art.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE DRAWINGS

FIG. 1 illustrates a perspective view of a composite single car garage door in accordance with an illustrative embodiment of the present invention with enlargements of indicated portions of the door shown in FIG. 1A and FIG. 1B.

FIG. 2 illustrates a front view of a composite single car garage door in accordance with an illustrative embodiment of the present invention.

FIG. 3 illustrates a perspective view of a composite two car garage door in accordance with an illustrative embodiment of the present invention.

FIG. 4 illustrates a composite two car garage door in accordance with an enlargement of the indicated region shown in FIG. 4A.

FIG. 5 illustrates a composite two car garage door in accordance with an illustrative embodiment of the present invention with an enlargement of the indicated region shown in FIG. 5A.

FIG. 6 illustrates a perspective view of various components used to make a composite garage door in accordance with an illustrative embodiment of the present invention.

FIGS. 7A and 7B illustrate an embodiment of a process used to manufacture single car composite garage door panels in accordance with the present invention, where FIG. 7A illustrates a process used to make a flush door panel, and FIG. 7B illustrates processes used to add raised surfaces to flush door panels.

FIG. 8 illustrates an embodiment of a method that may be used to make a thin-layer wood composite doorskin.

FIGS. 9A-9E illustrate an embodiment of a method used to make water-resistant thin-layer wood composites in accordance with an embodiment of the present invention where panel (a) illustrates mixing of the lignocellulosic fiber and resin; panel (b) illustrates forming the composite into a loose mat; panel (c) illustrates spraying the loose mat with release agent; panel (d) illustrates pressing the mat between two dies; and panel (e) illustrates the resultant thin-layered composite product.

### DETAILED DESCRIPTION OF SEVERAL EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular.

The present invention provides for the manufacture of thin-layer lignocellulosic composites that include levels of isocyanate-based resins that protect the composite from shrinking and swelling upon exposure to the elements. The invention may be applied to various types of lignocellulosic thin-layer composites to generate structural units that may be exposed to weathering by heat, moisture, air, and the like. In an embodiment, the present invention describes a method to make wood-based doorskins for exterior use that are resistant to shrinking and swelling.

Thus, the present invention comprises a method to produce a thin-layer lignocellulosic composite having increased resistance to moisture-induced shrinking and swelling comprising: (a) forming a lignocellulosic composite mixture comprising at least one type of lignocellulosic fiber having a predefined moisture content of at least about 3% by weight and at least 5% by weight of an organic isocyanate resin, a release agent that does not interfere with subsequent processing of the thin-layer composites, and, optionally, a wax; (b) pre-pressing the mixture into a loose mat; and (c) pressing the mat between two dies at an elevated temperature and pressure and for a sufficient time to further reduce the thickness of the mat to form a thin-layer composite of predetermined thickness, and to allow the isocyanate resin to interact with the lignocellulosic fiber such that the resultant thin-layer composite has a predetermined resistance to moisture.

The present invention also comprises thin-layer lignocellulosic composites made by the methods of the invention. Thus, in another embodiment, the present invention also comprises a thin-layer lignocellulosic composite comprising a mixture of no more than 95% by weight of at least one type of lignocellulosic fiber, wherein the fiber has a predetermined moisture content of at least about 3% by weight, and at least 5% by weight of an organic isocyanate resin, a release agent that does not interfere with subsequent processing of the thin-layer composite, and, optionally, a wax, wherein the mixture is pressed between two dies at an elevated temperature and pressure and for a sufficient time to form a thin-layer composite of predetermined thickness and to allow the isocyanate resin to interact with the lignocellulosic fiber such that the resultant thin-layer composite has a predetermined resistance to moisture.

Embodiments of the present invention comprise products such as panels for composite doors and doors made using such panels. Thus, one embodiment of the present invention may comprise a product having a thin-layer lignocellulose composite that comprises a region of increased thickness to provide at least one raised surface, such that the raised surface comprises the appearance of wooden planking and/or wooden trim. The raised surface may comprise a lignocellulose composite plant-on structure in communication with the thin-layer lignocellulose composite. Alternatively and/or additionally, the raised surface may be formed by making at least one cut in the thin layer composite such that the portion of the composite next to the cut-out region comprises a raised surface. In alternate embodiments, the cut-out portion may comprise grooves or other types of hollowing of the thin-layer lignocellulose composite.

The product may comprise any building structure for which it may be desired to emulate a surface having the appearance of at least one of wooden planking or wooden trim. For example, the thin-layer lignocellulose composite may comprise a surface of a door panel. In one embodiment, the panel may comprise a panel for a garage door.

Embodiments of the present invention may also comprise doors comprising a plurality of panels, wherein at least one panel comprises a thin-layer lignocellulose composite comprising a region of increased thickness to provide at least one raised surface, such that the raised surface comprises the appearance of wooden planking and/or wooden trim. The raised surface may comprise a lignocellulose composite plant-on in communication with the thin-layer lignocellulose composite, and/or the raised surface may be formed by cutting grooves or other types of hollowing of the thin-layer lignocellulose composite. In one embodiment, the door may comprise a garage door.

As used herein, “lignocellulose” comprises a material containing both cellulose and lignin. Suitable lignocellulosic materials may include wood particles, wood fibers, straw, hemp, sisal, cotton stalk, wheat, bamboo, jute, saltwater reeds, palm fronds, flax groundnut shells, hard woods, or soft woods, as well as fiberboards such as high density fiberboard (HDF), medium density fiberboard, (MDF), oriented strand board (OSB), and particle board. In an embodiment the lignocellulosic fiber is refined. As used herein, refined fiber may comprise fibers and fiber bundles that have been reduced in size from other forms of a lignocellulose substrate such as chips and shavings. In an embodiment, the lignocellulosic composites of the present invention comprise wood fiber. Refined wood fiber may be produced by softening the larger wood particles with steam and pressure and then mechanically grinding the wood in a refiner to produce the desired fiber size. In at least one embodiment, the lignocellulosic fiber is not refined.

As used herein, a thin-layer composite comprises a flat, substantially planar structure that is significantly longer and wider than it is thick. Examples of thin-layer lignocellulosic composites include wood-based doorskins that are used to cover the frame of a door to provide the outer surface of the door such as a garage door. Such doorskins may be only about 1 to 13 mm thick, but may have a surface area of about 20 square feet (1.86 square meters) or more. Other thin-layer lignocellulosic products may include MDF, hardboard, particle board, OSB and other panel products made with wood. These products are normally 3 to 20 mm in thickness.

As used herein, a “lignocellulose composite” comprises a product produced by bonding lignocellulose fibers by heat and pressure. Such composites may use a resin to promote bonding of the lignocellulose fibers. For example, lignocellulosic composite products may include HDF, MDF, hardboard, particleboard, OSB, and other panel products.

Also as used herein, a “thin-layer composite” comprises a flat, planar structure that is significantly longer and wider than it is thick. Examples of thin-layer lignocellulosic composites include wood-based door skins that are used to cover the frame of a door to provide the outer surface of the door. Such door skins may be only a few millimeters (mm) thick, but may have a surface area of several square feet or more. For example, a standard door skin for a single garage door panel may be about 24 inches wide by about 112 inches long and about ⅛ inch thick.

As used herein, a “plant-on” comprises a structure that may be adhered to, or “planted-on” the inner or outer surface of a planar object to provide a raised surface. In one embodiment, the plant-on structure may comprise a decorative trim. The plant-on structure may be made of a material that is compatible with the surface to which it is being adhered. For example, for a lignocellulose door or panel, a plant-on may comprise a lignocellulose composite. The plant-on structure may have a variety of shapes or forms. In one embodiment, the plant-on structure may be about ¾ inch thick and rectangular in shape. Or, a plant-on may comprise a lignocellulosic composite structure that is ½ inch thick and oval or round in shape.

As used herein, a cut out portion comprises a type of cut or gouge made in a surface. For example, a flat or flush door skin may have grooves that are about 1/16 inch deep and ¾ inch wide routed in the door skin. The grooves may be substantially linear, or they may be shaped to form a decorative molding.

Also, as used in describing the various surfaces of the thin-layer composites (e.g., door skins), the term “outer surface” refers to the surface of the thin-layer composite that is exposed on either face of a composite door panel, and the term “inner surface” refers to the surface that is adjacent to the frame and inner core of the panel. In contrast, the term “outside surface” or “outside facing surface” refers to the surface of the panel that is (or is designed to be) facing the outside of a building, and the term “inside surface” or “inside facing surface” refers to the surface of the garage panel that is (or that is designed to be) facing the inside of the building. Also, a substantially flat surface comprises a surface that may have some grain, texture, or some other pattern into the surface, but that does not comprise regions of high relief. In contrast, a raised surface comprises a design that stands out, or projects from the surface.

In an optional embodiment, the lignocellulosic composite mixture further comprises at least one type of wax. For example, the mixture may comprise up to about 2% by weight of wax. In one embodiment, the wax is present in an amount between about 0.1% and about 1% by weight. In an embodiment, about 0.5% by weight wax is used.

The wax may impart additional short-term water repellency to the wood composite. The type of wax used is not particularly limited, and waxes standard in the art of wood fiber processing may be used. Generally, the wax should be stable to the temperatures used for pressing the wood/resin mixture into a thin layer, increase the water repellency of the wood, and not adversely affect the aesthetics or subsequent processing (such as priming or gluing the wood composite). Thus, the wax may be a natural wax or synthetic wax, generally having a melting point in the range of about 120° F. (49° C.) to about 180° F. (82° C.). Waxes used may include, but are not limited to, paraffin wax, polyethylene wax, polyoxyethylene wax, microcrystalline wax, shellac wax, ozokerite wax, montan wax, emulsified wax, slack wax, and combinations thereof.

As described herein, the lignocellulosic mixtures of the present invention are pressed into thin-layers using flat or molded dies at conditions of elevated temperature and pressure. In an embodiment, the mixture is initially formed into a loose mat, and the mat is placed in the die press. Because the composite includes amounts of resin that are sufficient to increase the water resistance of the composite mixture, the composite may stick to the surface of the dies that are used to press the mat into the resultant thin layer composite. Thus, in an embodiment, the method may include steps to reduce sticking of the thin-layer composite to the dies.

In an embodiment, the method includes exposing the lignocellulosic composite mixture to a release agent prior to pressing the composite between the dies. In an embodiment, the release agent comprises an aqueous emulsion of surfactants and polymers. For example, the release agent may comprise compounds used in the doorskin manufacturing industry such as, but not limited to, 8105W, 8107W, CS1093A (Chemtrend, Howell, Mich.), PAT®87299/D2, or PAT®R1667 (Wurtz GmbH & Co., Germany).

The release agent may be added directly to the lignocellulosic composite mixture as an internal release agent prior to pre-pressing the mixture into a loose mat. Alternatively and/or additionally, the release agent may be sprayed on the surface of the mat before the mat is pressed into a thin layer.

Where the release agent is added directly to the mixture as an internal release agent, the amount of release agent added may range from about 0.5 to about 3 weight percent of the mixture. In one embodiment, about 2 weight percent release agent is used. The release agent utilized should not significantly interfere with subsequent processing of a finished product. For example, fatty acid release agents tend to migrate to the surface during processing and interfere with subsequent processing. For this reason, fatty acid release agents are disfavored in the present invention and, if used, should only be used in minor amounts.

Where the release agent is sprayed onto a surface of the mat, the amount of release agent sprayed onto the mat surface may comprise from about 0.1 to about 8.0 grams solids per square foot (1.1 to 86.1 grams per square meter) of mat surface. In another embodiment, the amount of release agent sprayed on the mat surface may comprise about 4 grams solids per square foot (43 grams per square meter) of mat surface. The release agent may be applied as an aqueous solution. In an embodiment, an aqueous solution of about 25% release agent is applied to the mat surface. When the thin-layer composite comprises a doorskin, the release agent may be applied to the surface of the mat that corresponds to the surface that will become the outer surface of the doorskin.

In an embodiment, the thin-layered lignocellulosic composite is colored. For example, in one embodiment, the release agent may comprise a pigment. In this way, an even coloring is applied to the thin-layered lignocellulosic composite.

Thus, the thin-layer lignocellulosic composites of the present invention may comprise wood fibers as well as wax and/or a release agent. For example, in an embodiment, the present invention comprises a wood composite comprising a mixture of: (i) no more than 95% by weight of a wood fiber, wherein the wood fiber has a predetermined moisture content of at least about 3% by weight; (ii) at least 5% by weight of an organic isocyanate resin; (iii) optionally, at least 0.1% by weight of a wax; and (iv) optionally, at least 1% internal release agent by weight and/or at least 0.1 grams release agent per square foot (1.1 grams per square meter) on the surface of the composite.

In some embodiments, the present invention may include a tackifier, such as those tackifiers known in the art. In other embodiments, the present invention may be substantially free of tackifier.

In some embodiments, it may be desirable to include fiberglass in the mixture. Fiberglass may be incorporated, among other reasons, to further improve the linear expansion of the present thin-layer composites. In some embodiments, between about 1% and 15% by weight fiberglass may be added. In other embodiments, between about 3% and 6% by weight fiberglass may be added. In still other embodiments, about 5% by weight fiberglass may be added to the mixture.

Other strategies may be used to reduce sticking of the lignocellulosic composite to the dies used for making the resultant thin-layer composite. Thus, in another embodiment, at least one surface of the die used to press the mat is exposed to an anti-bonding agent. In an embodiment, exposing the die to an anti-bonding agent may comprise coating at least one of the dies used to press the mat with an anti-bonding agent. In an embodiment, coating the die may comprise baking the anti-bonding agent onto the die surface. In one embodiment, the anti-bonding agent does not interfere with subsequent processing of the resultant composite should traces of the anti-bonding agent adhere to the composite during pressing.

In an embodiment, the release agent is not the same as an anti-bonding agent. The release agent comprises a compound that will not interfere with subsequent processing of the resulting thin-layer composite. In contrast, the anti-bonding agent may comprise compositions known in the art of pressing wood composites as being effective in preventing sticking to the pressing dies, but that may be problematic if included as part of the composite.

For example, in an embodiment, the anti-bonding agent used to coat the die surface is selected from the group consisting of silane, silicone, siloxane, fatty acids, polycarboxyl compounds and combinations thereof. Thus, the anti-bonding agent used to coat the die surface may comprise anti-bonding agents known in the art of die pressing such as, but not limited to, 7000W (Chemtrend, Howell, Mich.), CrystalCoat MP-313 and Silvue Coating (SDC Coatings, Anaheim, Calif.), Iso-Strip-23 Release Coating (ICI Polyurethanes, West Deptford, N.J.), aminoethylaminopropyltrimethoxysilane (Dow Corning Corporation), or the like.

For thin-layer exterior doorskins, the die that is coated with the anti-bonding agent may preferably correspond to the die used to press the outside surface of the doorskin. Alternatively, both dies may be coated with an anti-bonding agent. In an embodiment, the amount of anti-bonding agent used to coat the die surface may range in thickness from about 0.0005 to about 0.010 inches (i.e., about 0.0127 mm to about 0.254 mm). Thus, in one embodiment, the amount of anti-bonding agent used to coat the die surface comprises about 0.003 inches (i.e., about 0.0762 mm).

In an embodiment, coating the die comprises baking the anti-bonding agent onto the die surface. For example, in one embodiment, the step of baking the anti-bonding agent onto the die surface may comprise the steps of: (i) cleaning the die surface free of dirt, dust and grease; (ii) spraying from about 0.0005 to 0.0010 inches (0.5 to 10 mils or about 0.0127 to 0.254 mm) of a 50% solution of the anti-bonding agent onto the die; and (iii) baking the die at greater than 300° F. (149° C.) for about 1 to 4 hours. A primer coat may be first applied to the die surface prior to applying the anti-bonding agent to improve the adhesion of the anti-bonding agent to the die surface.

In some embodiments, the step of coating at least one die with an anti-bonding agent may comprise including multiple coats of bonding agent on the at least one die. For example, the at least one die may include 1, 2, 3, 4, 5, 6, 7, 8, 9 or more coats of anti-bonding agent.

Similarly, when at least one coat of anti-bonding agent is applied to the at least one die the application may not be necessary between each pressing step. For example, when pressing cycles are conducted on a regular basis, such as daily in a manufacturing facility, the anti-bonding agent may only need to be applied periodically. In some embodiments, the application may be hourly, daily, every couple of days, weekly, bi-weekly, monthly, some combinations thereof, etc.

In an embodiment, the step of exposing the pre-pressed mat to at least one release agent and/or anti-bonding agent may comprise adding an internal release agent and/or spraying one side of the mat with a release agent and also coating at least one die surface with an anti-bonding agent. In this embodiment, the side of the mat coated with the release agent is the surface opposite to the surface of the mat exposed to the coated die. For example, in an embodiment, the present invention comprises a method to produce a thin-layer wood composite having increased water resistance comprising the steps of: (a) Forming a mixture comprising: (i) a refined wood fiber comprising a predefined moisture content of at least about 3% by weight; (ii) optionally, a wax; (iii) at least 5% by weight of an organic isocyanate resin; (iv) optionally, a tackifier, (v) optionally, fiberglass, and (vi) optionally, a release agent; (b) pre-pressing the mixture into a loose mat; (c) optionally, spraying one surface of the mat with a release agent; and (d) pressing the mat between two dies at an elevated temperature and pressure and for a sufficient time to further reduce the thickness of the mat to form a thin-layer composite of predetermined thickness, and to allow the isocyanate resin to interact with the wood fibers such that the doorskin has a predetermined resistance to moisture, wherein at least one of the die surfaces has been coated with an anti-bonding agent.

The thin-layered lignocellulosic composites of the present invention may comprise a range of fiber compositions. Thus, in an embodiment, the lignocellulosic composite mixture comprises about 80% to about 95% by weight fiber.

The thin-layered wood composites of the present invention may comprise lignocellulosic fiber comprising a range of moisture levels. In an embodiment, the method does not require dehydrating the lignocellulosic fiber prior to treatment with the resin. Thus, in an embodiment, the lignocellulosic fiber comprises from about 3% to about 20% moisture content by weight. In another embodiment, the lignocellulosic fiber may comprise from about 5% to about 15% moisture by weight, in other embodiments, between about 6% and about 14%, in still other embodiments between about 7% and about 13%. In some embodiments the moisture content is about 9%.

In some embodiments, it may be desirable to spray additional moisture onto the mixture prior to pressing the mixture to facilitate the interaction of the isocyanate resin and the lignocellulosic fibers.

The organic isocyanate resin used may be aliphatic, cycloaliphatic, or aromatic, or a combination thereof. Also, although monomers may be preferred, polymeric isocyantates may also be used. In an embodiment, the isocyanate may comprise diphenylmethane diisocyanate (MDI) or toluene diisocyanate (TDI) such as Lupranate®M20FB Isocyanate (BASF Corporation, Wyandotte, Mich.) For example, in an embodiment, the isocyanate comprises diphenylmethane-4,4′-diisocyanate. Or, in an embodiment, the isocyanate is selected from the group consisting of toluene-2,4-diisocyanate; toluene-2,6-diisocyanate; m-phenylene diisocyanate; p-phenylene diisocyanate; chlorophenylene diisocyanate; toluene-2,4,6-triisocyanate; isophorone diisocyanate; diphenylmethane-4,4′-diisocyanate; 3,3′-dimethyldiphenylmethane-4,4′-diisocyanate; m-phenylene diisocyanate; p-phenylene diisocyanate; chlorophenylene diisocyanate; toluene-2,4,5-triisocyanate; 4,4′4″-triphenylmethane triisocyanate; diphenyl ether 2,4,4′-triisocyanate; hexamethylene-1,6-diisocyanate; tetramethylene-1,4-diisocyanate, cyclohexane-1,4-diisocyanate; naphthalene-1,5-diisocyanate; 1-methoxyphenyl-2,4-diisocyanate; 4,4′-bipheylene diisocyanate; 3,3′-dimethoxy-4,4′-biphenyl diisocyanate; 3,3-dimethyl-4,4′-biphenyl diisocyanate; 4,4′-dimethyldiphenylmethane-2,2′,5,5′-tetraisocyanate; 3,3′-dichlorophenyl-4,4-diisocyanate; 2,2′,5,5′-tetrachlorodiphenyl-4,4′-diisocyanate; trimethylhexamethylene diisocyanate; m-xylene diisocyanate; polymethylene polyphenylisocyanates; and mixtures thereof.

A range of isocyanate resin levels may be used to make the thin-layer composites of the present invention. Thus, in an embodiment, the mixture used to form the composite may comprise from about 3% to about 20%, in other embodiments from about 4% to about 15% by weight resin solids. In another embodiment, the mixture may comprise between 5% and 9% by weight resin solids. In one embodiment, the mixture may comprise about 8% by weight resin solids. In other embodiments, there is no significant improvement in moisture-induced shrinking or swelling when greater than about 10% by weight resin is included.

The conditions used to form the thin-layer composite include compressing the mixture at elevated temperature and pressure for sufficient time to allow the isocyanate resin to interact with the wood fibers such that the resultant thin-layer composite has a predetermined resistance to moisture. The exact conditions used will depend upon the equipment used, the exterior environment (e.g., temperature, elevation), the manufacturing schedule, the cost of input resources (e.g., starting materials, electric power), and the like. Also, varying the temperature may allow for changes to be made in the pressure used or the time of pressing; similarly, changes in pressure may require adjustment of the time and/or temperature used for pressing the thin-layer composites of the present invention.

A range of temperatures may be used to promote interaction of the isocyante resin with the lignocellulosic fibers in the mixture. In an embodiment, the temperature used to press the mixture (or preformed mat) into a thin-layer composite may range from about 250° F. (121° C.) to about 400° F. (204° C). In another embodiment, the temperature used to press the mixture (or preformed mat) into a thin-layer composite may range from about 280° F. (138° C.) to about 350° F. (177° C.). Or, a temperature that is in the range of from about 310° F. (154° C.) to about 330° F. (166° C.) may be used.

Similarly, the levels of the pressure applied during the pressing of the thin-layer composite may vary depending on a variety of factors, such as the nature of the thin-layer composite that is being formed, the equipment being used, environmental conditions, production capabilities, and the like. Thus, in an embodiment, the pressure during the pressing step may range from about 2500 psi (176 kg/cm²) to about 150 psi (10.5 kg/cm²). In another embodiment, the pressure may be applied in a step-wise manner. In another embodiment, the pressure during the pressing step ranges from about 1200 psi (84.3 kg/cm²) to about 2500 psi (176 kg/cm²) for about 5 to 20 seconds followed by about 500 psi (35.16 kg/cm²) for 20 to 80 seconds. For example, in one embodiment, the pressure during the pressure step ranges from about 1200 psi (84.3 kg/cm²) to about 2500 psi (176 kg/cm²) for about 10 seconds to about 500 psi (35.16 kg/cm²) for about 50 seconds.

The thin-layer lignocellulosic composites of the present invention have increased resistance to moisture-induced shrinkage and swelling. As used herein, increased resistance to moisture comprises reduced shrinking and/or swelling of the thin-layer composite when the composite is exposed to conditions of low and high moisture, respectively, as compared to thin-layer lignocellulosic composites made by other methods, or using non-isocyanate resins. As used herein, a normal moisture level of a thin-layer composite typically ranges between 6% and 9%. Moisture contents below this range may be considered low moisture, and moisture contents above this range may be considered high moisture.

Thus, in an embodiment, when thin-layer composites of the present invention are exposed to an atmosphere where the moisture level is low, the composite of the present invention exhibits less shrinkage than thin-layer composites made with other resins. Also, in an embodiment, when thin-layer composites of the present invention are exposed to an atmosphere where the moisture level is high, the composite of the present invention exhibits less swelling than thin-layer composites made with other resins.

For example, in an embodiment, the thin-layer composite comprises up to 50% less linear expansion and thickness swelling after being immersed for 24 hours in 70° F. (21° C.) water than a thin-layer composite comprising comparable levels of an alternate (non-isocyanate) resin, such as urea formaldehyde. Also in an embodiment, the predetermined resistance to moisture comprises a thickness swelling of less than 15% after being immersed for 24 hours in water at 70° F. (21° C.).

Also in an embodiment, exterior doorskins made by the methods of the present invention are significantly less dense than doorskins made using traditional formaldehyde-based resins. Thus, in an embodiment, the thin-layer lignocellulosic composites of the present invention comprise a density of less than about 65 pounds per cubic foot (962 kg/m³). In another embodiment, the thin-layer lignocellulosic composites of the present invention may comprise a density of less than 55 pounds per cubic foot (881.5 kg/m³).

The plant-on attached to the thin layer composite, and/or the groove or other hollowing cut into the thin-layer composite, may be used to provide the outer surface of a door panel with a pattern. The pattern may provide a single-paneled door with a desired design feature. Alternatively, the pattern may be coordinated with other panels of a multi-paneled door so as to create a door having the appearance of a single panel door. The raised surface provided by the plant-on and/or the grooves may be used to form a garage door having multiple horizontal panels that has the appearance of a single panel spanning the vertical axis of the garage door.

For example, embodiments of the present invention may comprise products having a plurality of plant-ons attached to the surface of the thin layer composite and/or grooves or other types of cut-out portions cut or formed into the surface of the thin-layer composite. The plurality of plant-ons and or grooves may comprise a repeating pattern. Alternatively and/or additionally, plant-ons or grooves positioned on the surface of one panel may be coordinated with the pattern of plant-ons or grooves on other panels used to form a pattern that extends over multiple panels.

The plant-ons may be positioned on a door comprising a substantially flat, or flush thin layer composite door skin. Alternatively, the plant-ons may be positioned on a door skin that has been cut out or routed to have grooves or some other design.

The plant-on structure may be in direct communication with the outer surface of the thin-layer composite structure. Alternatively, and/or additionally, a plant-on structure may be in direct communication with the inner surface of the thin-layer composite structure. In one embodiment, the outer or inner surface in communication with the plant-on corresponds to the outside surface of the door. Or, the outer or inner surface in communication with the plant-on may correspond to the inside surface of the door. Thus, a plant-on may be adhered to the outside facing surface of the garage door, or the inside facing surface of the garage door, or to both inside and outside facing surfaces of the garage door.

The thin-layer composite and the plant-on may both be made of the same lignocellulose material. In one embodiment, a lignocellulosic material comprises a lignocellulosic fiber and a resin. For example, the lignocellulose material used for the plant-ons and the thin-layer composite to which the plant-on is attached may comprise medium density fiberboard made with, for example, a melamine-formaldehyde resin.

In some cases, the plant-ons are only used for the outside surface of the door panel or door. The thin-layer used on the composite that does not comprise a plant-on structure may comprise a material that is the same as, or different than, the material used for the thin-layer composite that comprises the plant-on. Also, because the inside of the door is not as exposed to the elements as the outside of the door, a thin-layer composite that is less weather resistant may be used. In an embodiment, the thin-layer used on the face of the door panel that does not comprise a plant-on (e.g., the inside door skin) is also a lignocellulose composite. For example, an HDF or an MDF thin-layer composite may be used for the inside door skin.

The plant-ons may be adhered onto the thin-layer composite that will form the outer surface of the door using a polyvinyl acetate glue or a hot-melt glue. Other adhesives, such as double-sided adhesive tape may also be used. Additionally, and/or alternatively, the plant-ons may be positioned using fasteners such as, for example, nails or screws. Also, a sealant may be used to prevent delamination of the applied plant-ons from the panel. In one example embodiment, a silicone sealant, such as an acrylic silicone caulk, may be used. Also, both the thin-layer lignocellulose composite and the plant-on may comprise a resin. Thus, in one embodiment, the plant-on may be bonded to the thin-layer composite by pressing the plant-on onto the thin-layer composite such that the two composites form a singular composite and the plant-on becomes part of the thin-layer composite door skin.

By having the thin-layer composite and the plant-ons formulated from the same material, there may be reduced stress at the point of attachment of the plant-ons since both materials will exhibit the same physical characteristics. For example, when made from the same material, both the thin-layer panel and the plant-on may shrink or swell in response to changes in moisture and/or temperature in a similar fashion, resulting in reduced stress at the point of plant-on attachment as the door is exposed to environmental weathering.

The plant-ons may be a variety of shapes and sizes such that they stand out from the surface of the thin-layer lignocellulose composite door skin to provide a raised surface or relief. In various alternative embodiments, the plant-ons may range from about 1/16 to about 2 inches in thickness, or from about ⅛ inch to 1 inch in thickness, or from about ¼ inch to ¾ inch in thickness. In one example embodiment, the plant-on may be about ⅜ inch thick.

As described above, the thin layer composite may comprise cut-out portions as a means to provide a raised surface. In one embodiment, the cut-out portions may be substantially linear, to appear as spaces between plank boards. For example, grooves may be spaced apart in a regular fashion across the surface of the thin-layer composite. Or the cut-out portions may be non-linear in shape, such that the raised portions appear as decorative moldings. In one embodiment, the cut-out portions are grooves that may range from about 1/16 to ⅛ deep into the surface of the thin layer composite and from about 1/16 to 1 inch wide across the groove. In an embodiment, grooves about 1/16 inch deep into the surface of the thin-layer lignocellulose composite and about ¾ inch wide across may be used. Also, the spacing between the cut-out portions may be varied. Where the raised surface is designed to appear as planking, the grooves may be spaced apart in a regular fashion. In one example embodiment, grooves may be spaced about four to eight inches apart.

The thin-layer composite comprising a raised surface may comprise a variety of thickness ranges based in part on the method used to make the raised surface. For example, where the thin-layer composite is cut out at least in part, a thicker composite may be used. In alternate embodiments, where a portion of the thin-layer composite is cut out, the thin layer composite may range from about ⅛ inch to about 1 inch, or from about ¼ inch to about ½ inch in thickness. Alternatively, where plant-ons are used to form the raised surface, the thin layer composite may be somewhat thinner. For example, where plant-ons are used to provide a raised surface, and the thin-layer composite is not cut out, the thin-layer composite may range in thickness from about ⅛ inch to about 1 inch, or from about ¼ inch to about ½ inch.

The doors and door panels of the present invention may also comprise a core material emplaced within, and bounded by, the frame and the two thin-layer composites that form the inside and outside surfaces of the panel. The core may be made of a variety of materials. The core may, for example, comprise synthetic polymer foam. Thus, the core may comprise an expanded polystyrene (EPS) foam or a polyurethane foam. Alternatively laminated veneer lumber (LVL) or cardboard may be used to at least partly fill the core. In other embodiments, the doors and/or door panels are substantially hollow such that the core comprises a substantial proportion of air.

The core material may comprise a density similar to the density of wood. In one embodiment, expanded polystyrene having a density of from about 1.0 to about 1.5 pounds per cubic foot (pcf) is used. In this way, the composite doors and door panels of the present invention may have the same “feel” as a wood door. For example, the composite door panel and/or door may sound like a wood door. Also, the composite door and/or door panel may have a weight that is similar to a solid wood door.

In one embodiment, the door panel may comprise translucent panels, e.g., windows made of glass, or plexiglass, or the like, inserted within the perimeters of the frame. The surface surrounding the glass panels may be flush with the outer surface of the panel, or it may comprise a plant-on or other type of trim to accentuate the window pane.

The present invention also comprises processes to make products such as composite doors and door panels having a raised surface or high relief design. In one embodiment, such doors and door panels may be used for garage doors.

For example, one embodiment of the present invention comprises a process for making a thin-layer lignocellulose composite comprising a region of increased thickness to provide at least one raised surface, such that the surface comprises the appearance of at least one of wooden planking or wooden trim as discussed above. The method may comprise the steps of (a) preparing at least one thin-layer lignocellulose composite comprising a substantially flat surface and at least one of the following: (b) making at least one cut into the substantially flat surface of the composite to provide a raised surface, or (c) attaching at least one thin-layer lignocellulose plant-on structure to the surface of the thin-layer lignocellulose composite to form a raised surface. In alternative embodiments, the cut-out portion may comprise grooves or other types of hollowing of the thin-layer lignocellulose composite.

The process may further comprise the steps of: (i) assembling a frame for a panel; and (ii) positioning the thin-layer composite on the frame to form at least part of the outer surface of the panel. In one embodiment, step (i) is performed prior to step (a) above, and step (ii) is performed prior to steps (b) and/or (e) above, such that the thin-layer composite is assembled on a frame prior to positioning the plant-on and/or making any cuts in the thin-layer surface. The panel may comprise a panel for a door. In one embodiment, the panel comprises a panel for a garage door.

In one embodiment, the raised surface is positioned on a thin-layer composite that comprises the outside surface of a panel. Additionally, a plant-on may be adhered to the surface of the door that will be the inside surface of a panel, or to both the outside and the inside surface of a panel.

The process may, in one embodiment, further comprise placing the frame on a second thin-layer substrate to form an enclosed panel prior to positioning the thin-layer composite that is to be treated to provide a raised surface. In one embodiment, the second thin-layer substrate comprises a side of the door that does not require a plant-on. Where the second thin-layer substrate does not require a plant-on, the thin-layer used on the second face of the garage door panel may comprise a material that is the same as, or different than, the material used for the face of the panel comprising the plant-on. In one embodiment, the thin-layer used on the second face of the garage door panel is a lignocellulose composite. For example, a high density fiberboard thin-layer composite may be used for the door panel that does not comprise a plant-on.

Also, in one embodiment, a cure material may be emplaced within, and bounded by, the frame and the two thin-layer composites that form the inside and outside surface of the door panel. The cure may be made of a variety of materials. The core may, for example, comprise a synthetic polymer foam. Thus, the cure may comprise an expanded polystyrene (EPS) foam or a polyurethane foam. Alternatively, other core materials such as cardboard or LVL may be used. Or the core may be substantially hollow, such that it is filed with air.

Embodiments of the present invention also comprise processes for making composite door panels where the panels have at least one raised surface such that the surface comprises the appearance of wooden planking and/or wooden trim. In one embodiment, the process comprises the steps of: (a) assembling a frame for the panel; (b) optionally, adding a cure material to at least part of the area within the frame; (c) positioning the frame on a first thin-layer lignocellulose composite; (d) positioning a second thin-layer composite on top of the frame; (e) pressing the panel to form a panel having two substantially flat surfaces formed by the thin-layer lignocellulose composites, and at least one of steps (f) or (g), wherein (f) comprises the step of making at least one cut into a substantially flat surface of at least one of the thin-layer composites to provide a raised surface, and (g) comprises the step of attaching at least one thin-layer lignocellulose plant-on structure to the surface of at least one of the thin-layer lignocellulose composites to form a raised surface.

In one embodiment, the raised surface provided by the plant-on and/or the cut-out portion of the thin-layer lignocellulose composite may be used to provide the outer surface of a door panel with a pattern. The pattern may provide a single-paneled door with a desired design feature. Alternatively, the pattern may be coordinated with other panels of a multi-paneled door so as to create a door having the appearance of a single panel door. For example, the raised surface provided by the plant-on and/or the cut-out portions may be used to form a garage door having multiple horizontal panels that has the appearance of a single panel spanning the vertical axis of the garage door.

The plant-ons may be positioned on a door comprising a substantially flat, or flush thin layer composite door skin such as those described above.

The thin-layer composite and the plant-on may both be made of the same lignocellulose material. In one embodiment, a lignocellulosic material comprises a lignocellulosic fiber and a resin. For example, the lignocellulose material used for the plant-ons and the thin-layer composite to which the plant-on is attached may comprise medium density fiberboard made according to the previously discussed methods.

In some cases, the plant-ons are only used for the outside surface of the door panel or door The thin-layer used for the surface of the door that does not comprise a plant-on structure may comprise a material that is the same as, or different than, the material used for the thin-layer composite that comprises the plant-on. In one embodiment, the thin-layer used on the face of the door panel that does not comprise a plant-on (e.g., the inside door skin) is also a lignocellulose composite. For example, an HDF or an MDF thin-layer composite may be used for the inside door skin. In some situations, because the inside of the door is not as exposed to the elements as the outside of the door, a thin-layer composite that is less weather resistant may be used.

The plant-ons may be adhered onto the thin-layer composite using a polyvinyl acetate glue or a hot-melt glue. Other adhesives, such as double-sided adhesive also be used. Additionally, and/or alternatively, the plant-ons may be positioned using small fasteners such as, for example, nails or screws. Also, a sealant may be used to prevent delamination of the applied plant-ons from the panel. In one example embodiment, an acrylic silicone caulk sealant may be used. Also, both the thin-layer lignocellulose composite and the plant-on may comprise a resin. Thus, in one embodiment, the plant-on may be bonded to the thin-layer composite by pressing the plant-on onto the thin-layer composite such that the two composites form a singular composite and the plant-on becomes part of the thin-layer composite door skin.

The plant-ons may be a variety of shapes and sizes such that they stand out from the surface of the garage door to provide raised surface or relief. In various alternative embodiments, the plant-ons may range from about 1/16 to 2 inches in thickness, or from about ⅛ inch to 1 inch in thickness, or from about ¼ inch to ¾ inch in thickness. In one example embodiment, the plant-on may be about ⅜ inch thick.

As described above, the thin layer composite may comprise cut-out portions as a means to form a raised surface. In one embodiment, the cut-out portions may be substantially linear, to appear as spaces between plank boards. For example, grooves may be spaced apart in a regular fashion across the surface of the thin-layer composite. Or the cut-out portions may be non-linear in shape, such that the raised portions appear as decorative moldings. In one embodiment, the cut-out portions are grooves that may range from about 1/16 to ⅛ inch deep into the surface of the thin layer composite and from about ¼ to 1 inch wide across the groove. In an embodiment, grooves about 1/16 inch deep and about ¾ inch wide across may be used. Also, the spacing between the cut-out portions may be varied. Where the raised surface is designed to appear as planking, the grooves may be spaced apart in a regular fashion. In one example embodiment, grooves may be spaced about four to eight inches apart.

The thin-layer composite comprising a raised surface may comprise a variety of thickness ranges based in part, on the method used to make the raised surface. For example, where the thin-layer composite is cut out at least in part, a thicker composite may be used. In an embodiment, where a portion of the thin-layer composite is cut out, the thin layer composite may range from about ⅛ inch to about 1 inch, or from about ¼ inch to about ½ inch in thickness. Alternatively, where plant-ons are used to form the raised surface, the thin layer composite may be somewhat thinner. For example, where plant-ons are used to provide a raised surface, and the thin-layer composite is not cut out, the thin-layer composite may range from about 1/16 inch to about ½ inch in thickness, or from about ⅛ inch to about ¼ inch in thickness.

The frame may comprise at least two vertical stiles and two horizontal rails and a thin-layer composite comprising the inner face of the door. To provide an interlocking junction between adjacent panels of the garage door, the rails may be banded with pieces of pine or other types of wood to provide a means to have adjacent panels interlock. The band may include a protruding element (i.e., a tongue), or the pine band may include a groove so that the protruding element on the end of one garage panel may be inserted into a groove on another panel to provide an almost seamless, interlocking junction between the two panels. In one embodiment, the frame is made using LVL.

Once assembled, the panel may be exposed to conditions of elevated temperature and pressure to facilitate adhering the panel parts to one another. The panel may then be primed. Also, the process may include the step of placing windows in the door. The window panes may be made of glass, or plexiglass, or the like. The part of the panel surrounding the glass panels may be flush with the outer surface of the panel, or it may comprise a plant-on or other type of trim to accentuate the window pane. Finally, the panel may assembled to form a garage door. The door may be further decorated with hardware such as handles, knobs, knockers, straps, clavos, and the like.

Thus, the present invention comprises products, such as door panels and doors, made using a thin-layer lignocellulose composites made in accordance with the present invention that comprise a region of increased thickness to provide at least one raised surface, such that the surface comprises the appearance of wooden planking and/or wooden trim. The raised surface may comprise a lignocellulose composite plant-on structure in communication with the thin-layer lignocellulose composite. Alternatively, and/or additionally, the raised surface may be formed by making cuts in a portion of the thin-layer lignocellulose composite to thereby provide a raised surface in a portion of the composite that is adjacent to the cut-out portion.

The plant-on structures and/or the cut-out portions may be positioned to provide the door panel or door with a unique design. Because both the surface of the panel and the plant-on are made from a lignocellulose composite, the plant-on may be bonded to the door panel in such a manner as to become part of the door skin surface. Also, the doors may have the look and feel of solid wood doors.

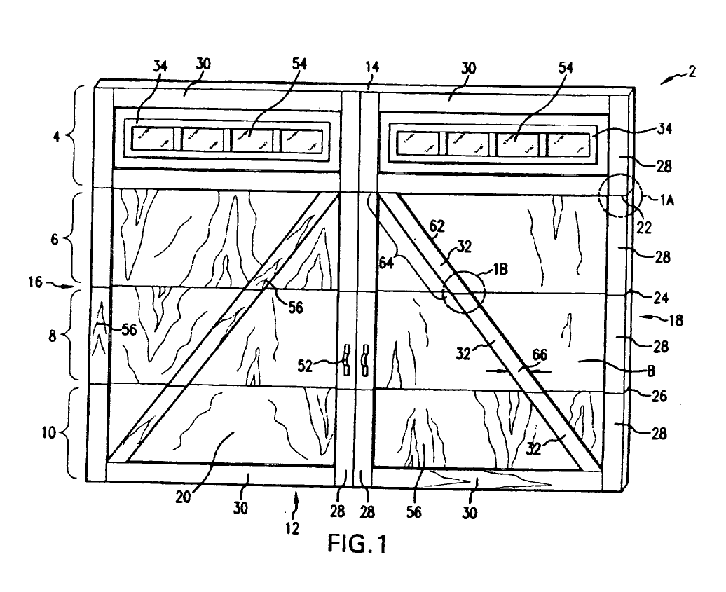

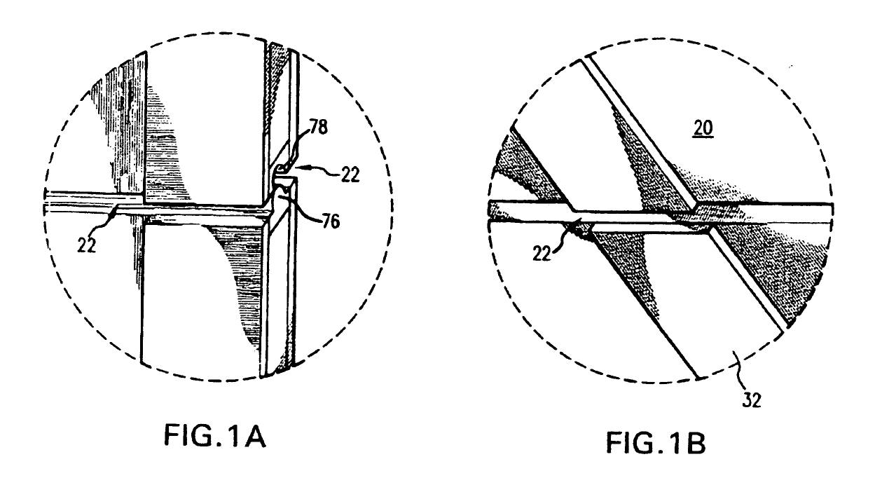

In one exemplary embodiment, the present invention may comprise a multi-paneled composite garage door that has the appearance of a single panel door. Various illustrative embodiments of exemplary garage doors and garage door panels of the present invention are shown in FIGS. 1-6. In the figures, various embodiments of a general design feature may be indicated. For example, the general design feature of a panel or a plant-on are shown as various embodiments of a panel (e.g., 4, 6, 8, or 10) or a plant-on (e.g., 28, 30, or 32). Also, while the invention is illustrated as being applied to the manufacture of garage doors, it may be applied to the manufacture of various wood-based products where the application of a raised surface may be desired. Thus, the plant-on structures of the present invention may be used to add a design to other types of doors, panels, walls, window frames, or almost any building structure.

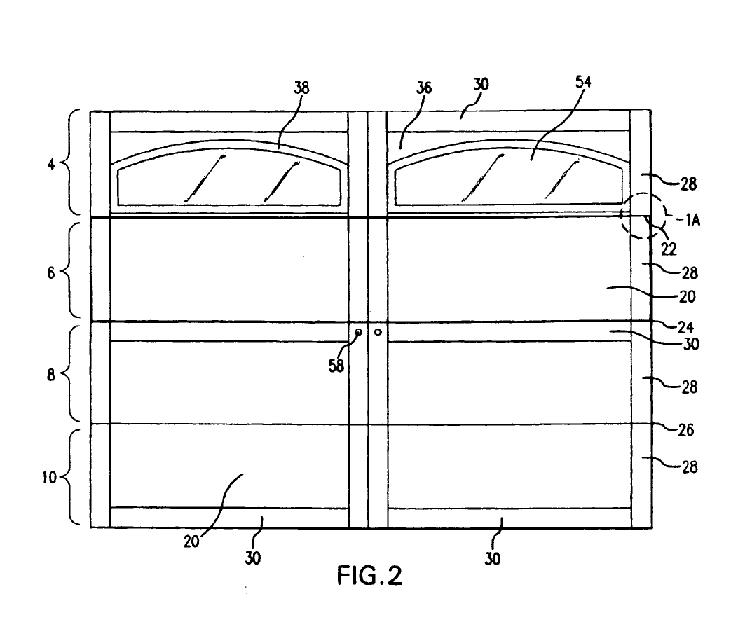

Referring now to FIG. 1, the garage doors 2 shown may comprise multiple composite panels 4, 6, 8, and 10, separated at junctures 22, 24, and 26. In FIG. 2. panel 6 is outlined to show the extent of the panels. Thus, it can be seen that the door may be continuous across its horizontal axis (see e.g., lower surface 12 and upper surface 14), but may be comprised of separate panels across its vertical axis (see e.g., left side 16 and right side 18). Thus, as shown in the exploded view of FIGS. 1A and 1B, although the adjacent panels 4, 6, 8, and 10 appear to form a single unified piece, there is actually a junction 22, 24, and 26, between the panels. In addition, the panels may be fashioned so that one panel may interlock with another door panel. For example, as illustrated in the exploded view shown in FIG. 1A, the seam 22 between panels 4 and 6 may comprise a protruding portion or tongue 76 on one panel, that fits into a groove 78 on an adjacent panel.

FIG. 1 shows an embodiment wherein multiple plant-ons have been positioned on the surface of the outer door skin of a garage door. By the positioning of various plant-ons on the outer surface of the door panel 20, the overall appearance of the door is not that of four horizontal panels, but of two single-panel swing doors. For example, plant-ons 28 (FIG. 1) may span the vertical length of the door, and mesh almost seamlessly at junctions 22, 24, and 26, to appear as a single vertical trim on the face of the door. Also, diagonally placed plant-ons 32 provide a single, unified design feature to create the impression that the door shown in FIG. 1 is actually two single paneled doors that may swing open, rather than a roll-up door made of four horizontal panels (4, 6, 8, and 10). Also, hardware pieces such as handles 52 may be used to further create the impression that the door shown in FIG. 1 is actually two single paneled doors that may swing open, rather than a roll-up door made of four horizontal panels. Even horizontal plant-ons 30, although they may not span different panels, provide a design that is coordinated with the other plant-ons so as to create the impression that the door shown in FIG. 1 is actually two single-paneled swing doors.

Both the outer surface of the garage door panel 20, and the plant-ons (e.g., 28, 30, and 32) may be made of a lignocellulose composite. For example, the thin-layer composite forming the outer surface and the plant-ons may both be made of the same lignocellulose material. In one embodiment, the lignocellulose material may comprise medium density fiberboard made using an isocyanate resin.

Referring again to FIG. 1, using a lignocellulose material allows for patterns simulating wood grain 56 to be included as part of the surface of the garage door. As used herein, a thin layer lignocellulose composite is substantially flat, and thus alone, does not comprise a raised surface. Because the plant-ons and the thin-layer composite used for the outer surface of the door are made of lignocellulose, the grain pattern 56 may be formed using dies etched with a grain pattern to form the thin-layer composite 20 and/or the plant-on (e.g., 28, 30, and 32).

Also, using a lignocellulose substrate to form the plant-ons and the thin-layer composite used as the outer surface of the door, allows for priming and painting of the garage door in a manner similar to solid wood. Thus, a variety of patterns and colors may be used with the composite garage doors of the present invention.

The plant-ons may be a variety of shapes and sizes such that they stand out from the surface of the garage door to provide raised surface or relief. In various alternative embodiments, the plant-ons may range from about 1/16 to 2 inches, or from about ⅛ inch to 1 inch, or from about ¼ inch to ¾ inch in thickness 62 (FIG. 1). In one example embodiment, the plant-on may be about ⅜ inch thick. The width 66 and length 64 (FIG. 1) of the plant-ons may vary depending upon the size of the door panel and the size of the trim required. In alternate embodiments, the plant-ons may range from about ¼ inch to 18 inches in width, or from about 1 inch to about 12 inches in width, or from about 3 inch to about 10 inches in width. The length of the plant-on may also vary, but generally will not be longer than the diagonal length of the panel. Also, different plant-ons on the same face of a door may be different sizes. For example, in one embodiment, the plant-ons 28, 30, and 32 used for the border shown in the door of FIG. 1 may be different sizes.

Still referring to FIG. 1, the door panel may comprise translucent panels 54 (e.g., windows) inserted within the perimeters of the frame. The surface of the garage door panel surrounding the window may be the door skin itself, or it may comprise a trim 34 to accentuate the window pane. In one embodiment, the trim may be a lignocellulose plant-on.

The panel itself may be sized to fit a standard garage door. In one embodiment, the panels are 78 to 144 inches across for use as a single car garage door (e.g., FIGS. 1 and 2). Alternatively, panels may range from 192 to 216 inches across for use as two car garage doors (e.g., FIGS. 3-6). Also, the vertical axis (i.e., height) for the panel may vary as needed. In one embodiment, four panels may be used for a garage door. Alternatively, three to six panels may be used for a garage door. Or, in some cases, the garage door may comprise a single panel. In some cases, panels of different sizes may be used for a single door. For example, in the case of a garage door including windows as part of the top panel, a larger top panel may be used with smaller lower panels. In one example embodiment, a top panel 24 inches in height may be used with three 20 inch lower panels. Or, four 21 inch high panels may be used. For example, where the window is 16 inches high, a 24 inch high panel may be preferred. In contrast, a 13 inch window may be fitted into a 21 inch high panel.

FIGS. 2-6 show alternative embodiments of the garage doors and door panels of the present invention. For example, FIG. 2 shows the use of plant-ons 36 and 38 to outline an arched window-pane 54. Also, placement of vertical plant-ons 28, and horizontal plant-ons 30, as well as knobs 58 provide the appearance of two single-paneled swinging doors.

FIG. 3 provides a schematic illustration of double (i.e., two vehicle) garage door of the present invention. Similar to FIGS. 1 and 2, FIG. 3 shows the use of multiple vertically placed plant-ons 40 to create the impression of vertical panels spanning the three bottom panels (6, 8, and 10) of the door. Also, placement of the outer vertical plant-ons 28 and horizontal plant-ons 30, provides the appearance of four single-paneled swinging doors 82, 84, 86, and 88.

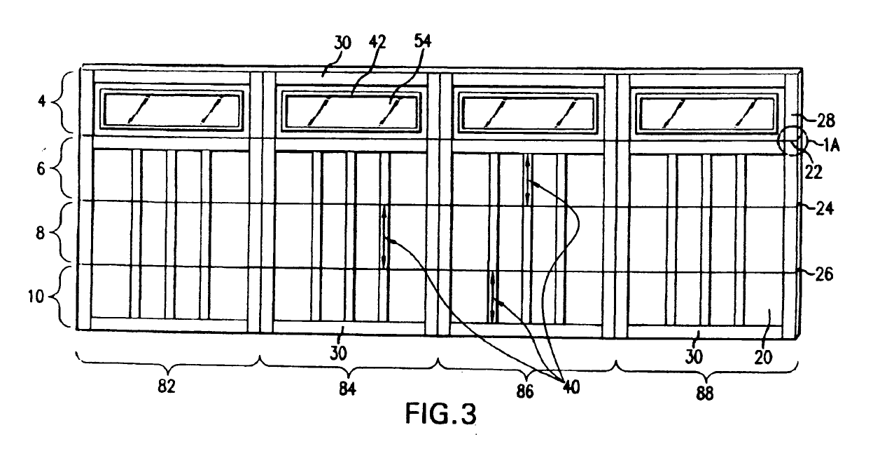

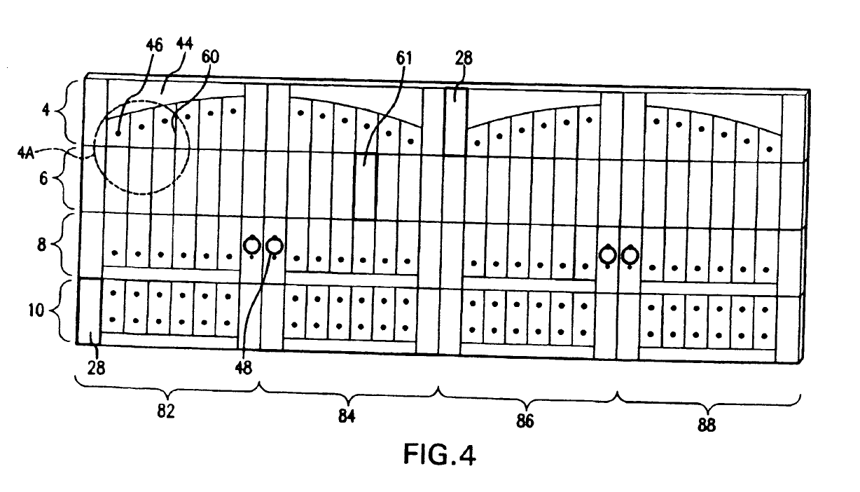

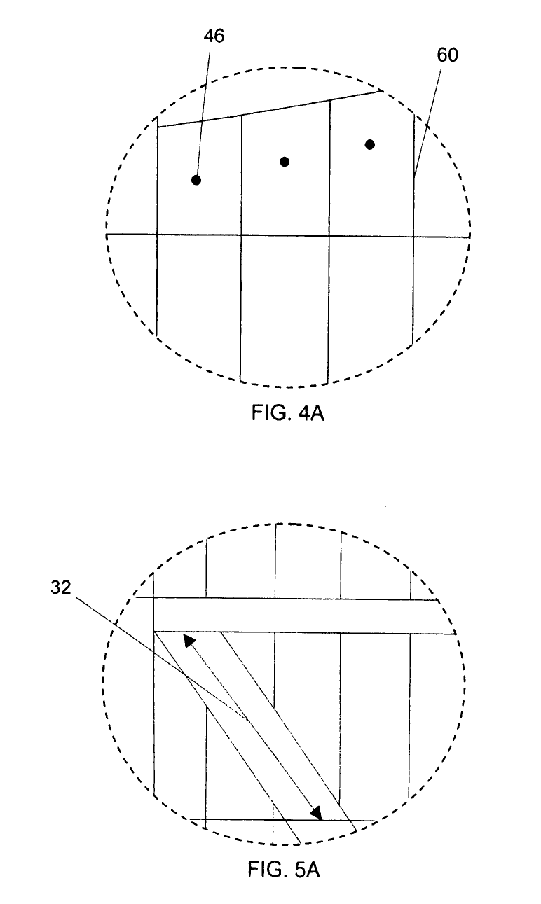

FIG. 4 illustrates another embodiment, in which portions of a ¼ inch thin-layer flush (i.e., substantially flat) lignocellulose composite may be cut-out to create a pattern. For example, grooves 60 may be routed or formed in a ¼ inch thin-layer lignocellulose composite door skin to create a pattern resembling multiple boards placed in a parallel fashion. Thus, in FIG. 4, each panel (4, 6, 8 and 10) is cut out to provide grooves 60. In this way, the portions of the door skin that are not cut out 61 resemble plank boards laid adjacent to one another. The panel may also comprise a plant-on (e.g., 44 and 28), positioned on top of the thin-layer lignocellulose door skin that has been cut-out at least in part. Thus, the door of FIG. 4 provides the appearance of multiple planks that are laid side to side and that are bordered with a wooden trim to provide the arch design and frame of the door. The positioning of the plant-ons 28 and 44 relative to the cut-out door skin 61 is shown as a perspective view in FIG. 4A. Also shown are decorative handles 48 and knobs 46 that convey the appearance that the door of FIG. 4 is made of four swinging door panels 82, 84, 86, and 88, rather than four horizontal panels 4, 6, 8, and 10.

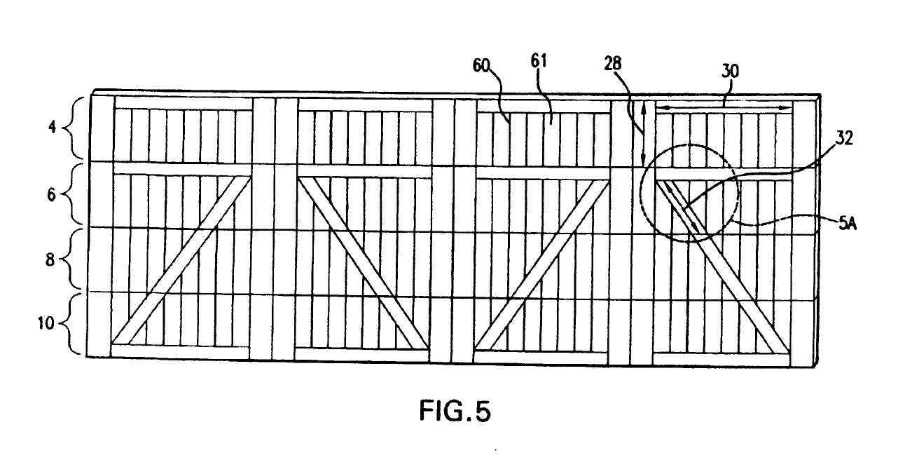

FIG. 5 illustrates another embodiment in which portions of a ¼ inch thin-layer flush (i.e., substantially flat) lignocellulose composite are cut-out to create a pattern which is further accentuated by the positioning of plant-ons on top of the door skin. As shown in FIG. 5, grooves 60 may be routed from a ¼ inch thin-layer lignocellulose composite door skin to create a pattern resembling multiple boards 61 placed in a parallel fashion. The panel may also comprise plant-ons 28, 30, and 32 that are positioned on top of the door skin that has been cut-out at least in part. The positioning of the plant-ons 28, 30, and 32 relative to the cut-out door skin 61 is shown as an enlarged, perspective view in FIG. 5A. Thus, similar to the door of FIG. 4, the door of FIG. 5 provides the appearance of multiple planks that are laid side to side and that are bordered with a wooden trim to convey the appearance that the door of FIG. 5 made of four swinging or sliding door panels, rather than four horizontal panels 4, 6, 8, and 10.

An example embodiment showing the components of a composite garage door panel of the present invention is shown in FIG. 6. As illustrated in FIG. 6, the composite door panels of the present invention may comprise a frame comprising at least two vertical stiles 72 and two horizontal rails 74. Generally, three vertical stiles are preferred for a panel that spans the width of a single vehicle garage door and five to seven vertical stiles may be used for a panel that spans the width of a two vehicle garage door. As is known in the art, the stiles may be positioned such that two stiles provide the perimeter of the frame and the other stiles are spaced equidistant from the end stiles and from one another. For example, a panel for a single car garage door may comprise two exterior (perimeter) stiles and one center (interior) stile. The frame maybe made using LVL, although other types of lumber may also be used. The panel may also comprise a first thin-layer composite 70 comprising the inside face of the door and a second thin layer composite 20 comprising the outside face of the door. The rails 74 may be banded with pieces made of pine or other types of wood to provide a means to have adjacent panels interlock such that an extruding element (e.g., tongue) 76 on one panel may be inserted into a groove 78 on another panel to provide an almost seamless junction between the two panels.

As described herein, exemplary doors and door panels according to the present invention may comprise a core synthetic polymer 80, such as expanded polystyrene (EPS) or polyurethane foam, emplaced within, and bounded by the frame and the two thin-layer composites that form the inner and outer surfaces of the door (e.g., door skins). In one embodiment, expanded polystyrene having a density of from about 1.0 to about 1.5 pounds per cubic foot (pcf) is used. Polymer products that may be used as the core are commercially available from Iowa EPS Products, Inc. (Des Moines, Iowa) or Plymouth Foam (Plymouth, Wis.).

The surface of the garage door facing the inside of the garage (e.g., 70, FIG. 6) may not require a design to the extent as may be desired on the outside facing surface (e.g., 20, FIG. 6) of the door. Thus, in many cases, the inside facing surface of the garage door panel may comprise a smooth surface. Or, a surface including a grain pattern to simulate natural wood may be used. The thin-layer composite used on the inside facing surface of the garage door panel may comprise a material that is the same as, or different than, the material used for the outside facing surface of the panel. For example, in certain applications, plastic or metal may be used as the inside facing-surface of the garage door panel. Generally, however, the thin-layer composite used on the inside facing surface of the garage door panel is a lignocellulose composite. For example, an HDF door skin may be used for the inside facing surface of the door. In one example embodiment, a flat, ⅛ inch thick, HDF door skin such as those commercially available from Georgia Pacific (Atlanta, Ga.), or Unilyn (Charlotte, N.C.) may be used for the inner garage door surface.

As shown in FIG. 6, the thin-layer composite 20 comprising the outside surface of the door may comprise a plurality of plant-ons 28, 30, and 32, to form a raised surface. As described above, the plant-ons may be a variety of shapes and sizes such that they stand out from the surface of the garage door to provide a raised surface or relief. Shown in FIG. 6 is a garage door panel having plant-ons 28, 30, and 32 adhered to the surface of the outer door skin 20 so as to provide the pattern for the garage door illustrated in FIG. 1. In one embodiment, the lignocellulose material may comprise medium density fiberboard made using an isocyanate resin.

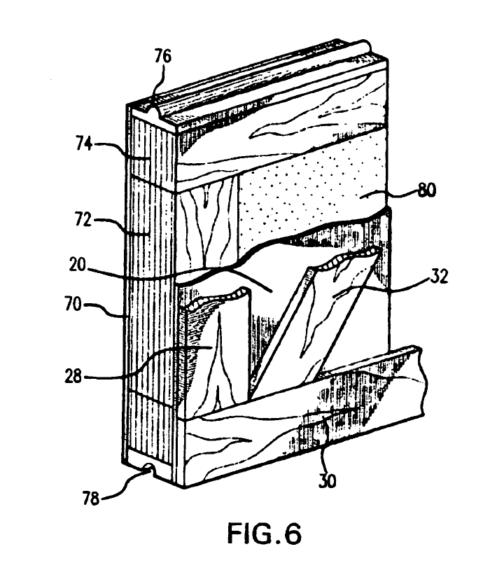

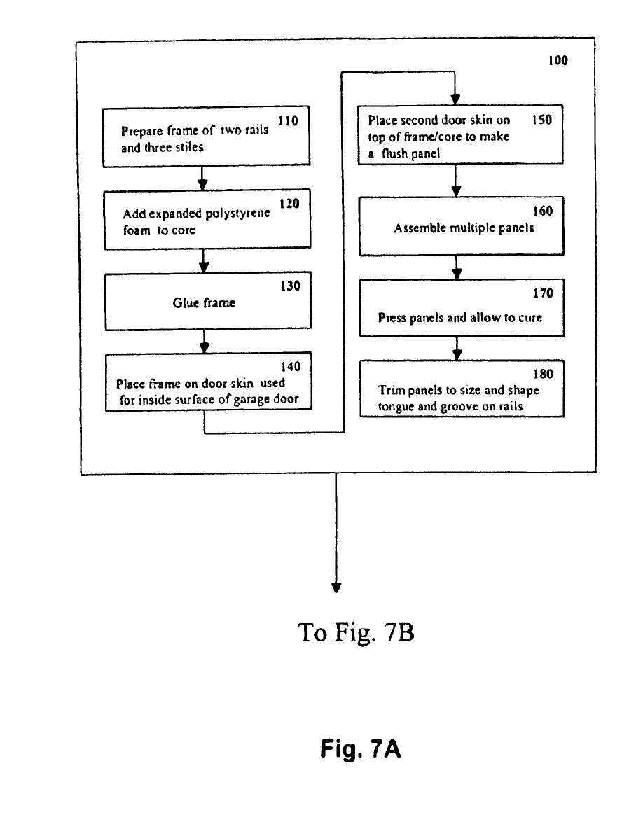

Embodiments of the present invention also include processes to make products such as composite garage doors and garage door panels comprising a raised surface. A schematic representation of a process that may be used to make composite garage door panels and doors of the present invention is provided in FIGS. 7A and 7B.

As shown in FIG. 7A, one step of assembling a product comprising a raised surface to resemble wooden planking and/or trim may comprise making a flush panel 100. As used herein, a flush panel is a panel having a substantially flat surface. For example, to assemble a flush panel, a frame comprising two or three stiles and two rails for a single vehicle door, or five to seven stiles and two rails for a double vehicle garage door, may be assembled using either glue or fasteners as is known in the art 110. For example, the frame may be assembled by stapling the frame together using aluminum corrugated staples. Next, small aluminum nails may be inserted in the edges of the stiles, and a material to form a core is positioned inside the frame by inserting the nails in the edges of the foam 120. In one embodiment, an expanded polystyrene foam core is applied within the perimeter of the frame.

At this point, a glue may be applied to the frame so that the frame may be attached to the door skins 130. In one embodiment, the frame with the core in place may be sent through a roller that applies a glue to the frame. For example, in an embodiment, a polyvinyl acetate glue employing an aluminum chloride catalyst may be used to adhere the frame to the door skins.

The assembled frame may then be positioned on a thin-layer lignocellulose composite that will form the inside surface of the garage door 140 (FIG. 7A). These door skins may be smooth, or may have a grain pattern. In one embodiment, a high density fiberboard may be used.

Generally, multiple assemblies comprising a frame, core, and two flush thin-layer composite surfaces may be assembled 160 then pressed 170 form panels. About 20 to 30 of the assembled structures may be stacked together and placed in a bag press, where they are pressed using air bags. For example, to press about 30 door panel assemblies, a pressure of about 20 to 50 psi may be applied for about 60 minutes. After pressing, the door panels may be allowed to cure. Cure times may vary depending upon the glues and resins used to make the panel, as well as the type of door skin and frame that may have been used. Cure times may range from 20 minutes to as long as 48 hours. In one embodiment, a cure time of about 4 hours is used.

Once the panels have cured sufficiently, they may be trimmed to size and shaped to include a tongue or groove on the rails 180. For example, a door trim saw may be used to trim one or both rails, and one or both outer stiles. Once the panel has been appropriately trimmed to size, the rails may be fashioned to include a portion comprising either a protruding piece (e.g., a “tongue”) or a groove. The tongue and groove pieces will allow the panels to interlock in a substantially seamless manner. For example, referring back to FIGS. 1 and 6, the protruding tongue 76 from the upper rail of panel 6, may insert into the groove 78 on the lower rail of panel 4, to provide an interlocking junction at 22.

At this point, and referring now to FIG. 7B, the panels may be bent to have portions of the door skin raised. Thus, the process may include the option 199 of having the flush panels bent to have portions of at least one of the door skins cut out 200. Alternatively, and/or additionally, the process includes glue alternative 299 of having the panels bent to have plant-ons applied 300.

Where the panels are to have grooves or other types of cut-out portions emplaced in the outer surface 200, the thin layer lignocellulose composite used as the outer surface may be thicker than a standard ⅛ door skin. For example, a ¼ inch lignocellulose composite may be used. To have grooves cut into the outer door skin, a router may be used to cut grooves in the door panel at predetermined positions 200. For example, in one embodiment, grooves ⅛ inch deep, and ⅜ inch wide are cut in the door panel every six inches.

Once the door panels have been cured and trimmed to size 100, and if needed, part of the surface cut-out to form a pattern 200, individual plant-on structures may be placed on the upper surface of the door skin to form the design required 300 (FIG. 7B). As shown in FIG. 7B, a step may comprise making the plant-on structures that may be applied to the thin-layer lignocellulose composite door skin. To form the plant-on structures, a lignocellulose sheet of the correct thickness is prepared 310 and then cut, or torn, to the correct size 320. For example, the plant-ons may be formed from ⅜ inch MDF thin-layer composite that has been cut to the correct size. In one embodiment, the plant-ons are cut manually. In an alternative embodiment, the plant-ons may be cut using a laser. More specifically, the plant-ons may be shaped using a multiple head ripsaw. For example, individual ⅜ inch MDF sheets may be fed into the rip saw having a blade configuration set to generate the proper widths needed for the plant-on material.

Once the appropriate plant-ons have been prepared, the plant-on may be positioned on the thin-layer lignocellulose composite 330. In one embodiment, an adhesive may be used. For example, an isocyanate adhesive may be applied to the plant-on structure using a roller or glue spreader. Alternatively, a double-sided adhesive tape may be used. Or a combination of tape with an adhesive spray may be employed. Also, hotmelt glue, such as National Starch reactive hotmelt may be used to apply the plant-on to a thin-layer lignocellulose composite resin. For example, in one embodiment, the plant-on material is applied using a polyvinyl acetate (PVA) glue catalyzed with aluminum chloride catalyst. The PVA may be applied at a rate of 8 to 10 mils thickness (0.008-0.010 inch). Also, the plant on may be further secured using a fastener, such as a nail, aluminum brad rivet, tack, or other fasteners known in the art.

Once the plant-on has been positioned on the panel, the panel may be subjected to pressure such that the plant-on is fixed onto the outer surface of the door panel 340. For example, the panel may be pressed for at least one hour at 20 psi air pressure using a bag press. Because the plant-on is made of the same lignocellulose material as the door skin to which it is attached, the surface plant-on will be compatible with the surface of the door skin such that the outer door skin will comprise a single structure having raised portions provided by the plant-on.

At this point the panels may be primed with primer 400. The process may further include the option 499 of sending the panels to have windows emplaced in the panel 500. To insert windows, an opening may be cut in the panel surface using, for example, a routing window cutout machine 510. The window frames may then be installed in the opening, caulked, and fastened together with screws 520. Decorative trim may then be put in place 520. The decorative trim may be pre-made trim such as plastic trim. Or, the decorative trim may comprise a plant-on.

Once the raised surfaces have been added to the panel, and if needed, windows emplaced, the process may include the option 599 of sending the panels to be assembled into doors 600. The pressed panel may be painted as required 610. Using a lignocellulose substrate to form the plant-ons and the thin-layer composite used as the outer surface of the door allows for priming and painting of the garage door in a manner similar to solid wood. Thus, a variety of patterns and colors may be used with the composite garage doors of the present invention. Although a variety of paint types may be used, a waterborne all-acrylic exterior latex finish with a UV inhibitor may be employed to provide a wide range of color choice, relative ease of application and substantial durability. Once the panels have been painted, they may be assembled as doors 620. Or, panels may be assembled as doors and then painted as needed.

The present invention is also concerned with methods to employ isocyanate resins to improve the moisture-resistance of thin-layer lignocellulosic composites, such as, but not limited to, wood doorskins. Isocyanate resins such as diphenylmethane-4,4′-diisocyanate (MDI) and toluene diisocyanate (TDI) resin are highly effective in modifying the reactive groups present on cellulose fibers to thereby prevent the fibers from reacting with water. It is believed that the isocyanate forms a chemical bond between the hydroxyl groups of the wood cellulose, thus forming a urethane linkage.

Efforts to develop isocyanate resins for thin-layer wood composites are described in U.S. Pat. No. 3,440,189, describing the use of isocyanate resin and a basic catalyst, U.S. Pat. No. 4,100,138, describing the use of an isocyanate and a polyether polyol binder, as well as U.S. Pat. No. 4,359,507, describing use of isocyanates mixed with ethylene carbonate and propylene carbonate as a binder. Also, U.S. Pat. No. 6,620,459 describes a method for impregnating wood substrates with an isocyanate resin by dipping the wood in the resin followed by subsequent polymerization steps, and U.S. Pat. Nos. 4,388,138 and 4,396,673 describe use of a binder of polyisocyanate and a wax release agent. U.S. Pat. No. 5,344,484 describes the use of low-temperature pressing to prepare isocyanate-bonded wood composites described as having high surface strength but porous enough such that adhesives can bond the treated thin-layer composite to an underlying wood frame. U.S. Pat. No. 5,344,484 describes that such wood composites include 1 to 4% isocyanate resin. Still, it has been found that such low levels of resin that do not provide consistent levels of moisture resistance to thin-layer wood composites.

To provide a thin-layer wood composite that is resistant to water, resin contents of greater than 5%, in some embodiments at levels of about 6%, up to about 15%, are required. However, there are problems when manufacturing thin-layer lignocellulosic composites using isocyanate-based resins at concentrations greater than 5%. For example, doorskins are generally on the order of 2 to 5 mm in thickness, with a total surface area of 20 square feet (i.e., 1.86 square meters). When such thin-layer wood composites made with 10% isocyanate resin are prepared using conventional pressing methods, the high resin levels typically cause the wood composite to stick to the pressing die used to prepare the doorskin after only a few pressing cycles.

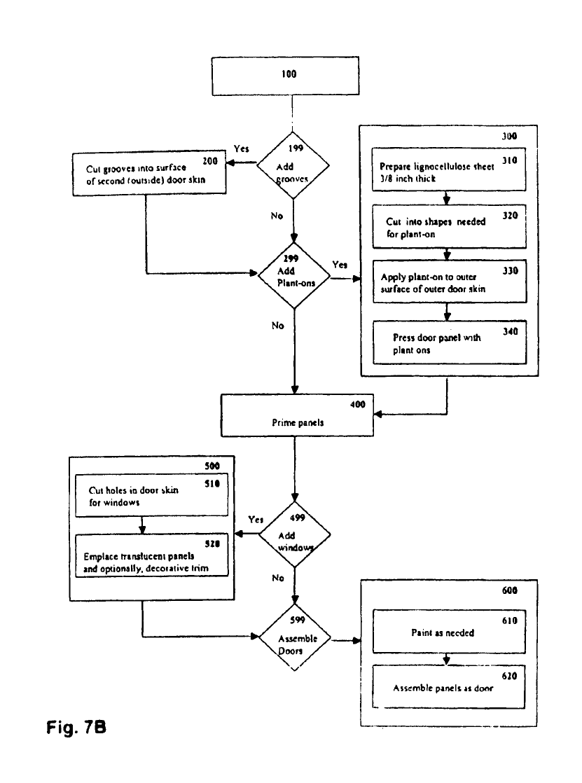

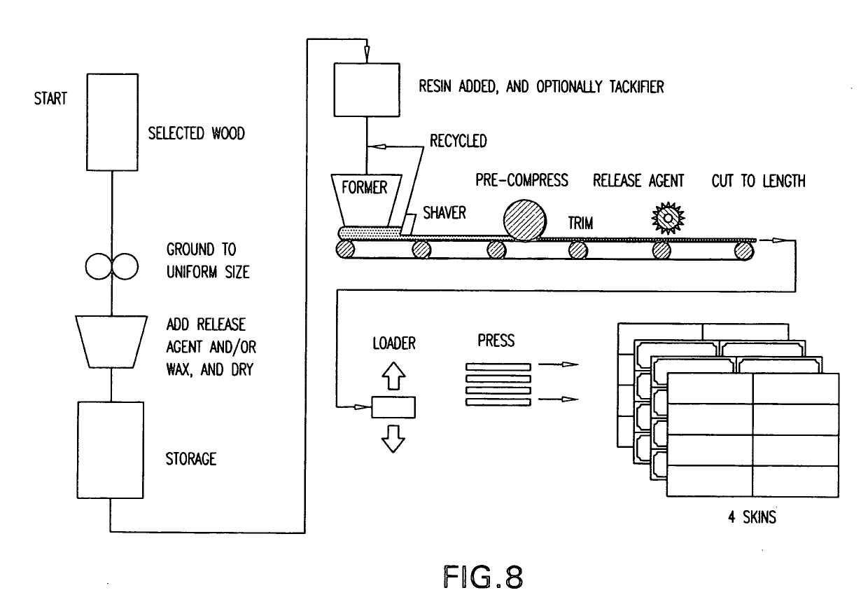

FIG. 8 shows an overview of a general method used to prepare doorskins. Generally, a selected wood starting material is ground to prepare fibers of a uniform size and the appropriate amount of release agent and/or wax added. The fiber/release mixture is dried to a determined moisture content. At this point the preparation may be stored until further processing. The fiber/release blend is then mixed with an appropriate binder resin and, optionally, a tackifier (e.g., using atomization), until a uniform mixture is formed. It is also common to add the resin to the fiber prior to storage of the fiber.

The mixture may then be formed into a loose mat which is pre-shaped using a shave-off roller and pre-compressed to a density of about 6-8 pounds per cubic foot. A release agent may be sprayed onto the surface of the mat after pre-compressing and before hot-pressing. After further trimming to the correct size and shape, the pre-pressed mat is introduced into a platen press, and compressed between two dies under conditions of increased temperature and pressure. For example, standard pressing conditions may comprise pressing at 320° F. at 2500 psi for 10 seconds followed by 50 seconds at 500 psi (i.e., about 160° C. at 84.3 kg/cm² for 10 seconds followed by 50 seconds at 35.2 kg/cm²). Generally, a recessed (female) die is used to produce the inner surface of the doorskin, and a male die shaped as the mirror image of the female die is used to produce the outside surface of the skin. Also, the die which is forming the side of the doorskin that will be the outer surface may include an impression to create a wood grain pattern. After cooling, the resulting doorskin is sized, primed, optionally, humidified, and mounted onto a doorframe using a standard adhesive and employing methods standard in the art.

Embodiments of the present invention recognize that the use of a release agent and/or an anti-bonding agent during the manufacture of wood composite doorskins allows for increased levels of resin to be used for the manufacture of doorskins made by low-temperature pressing.

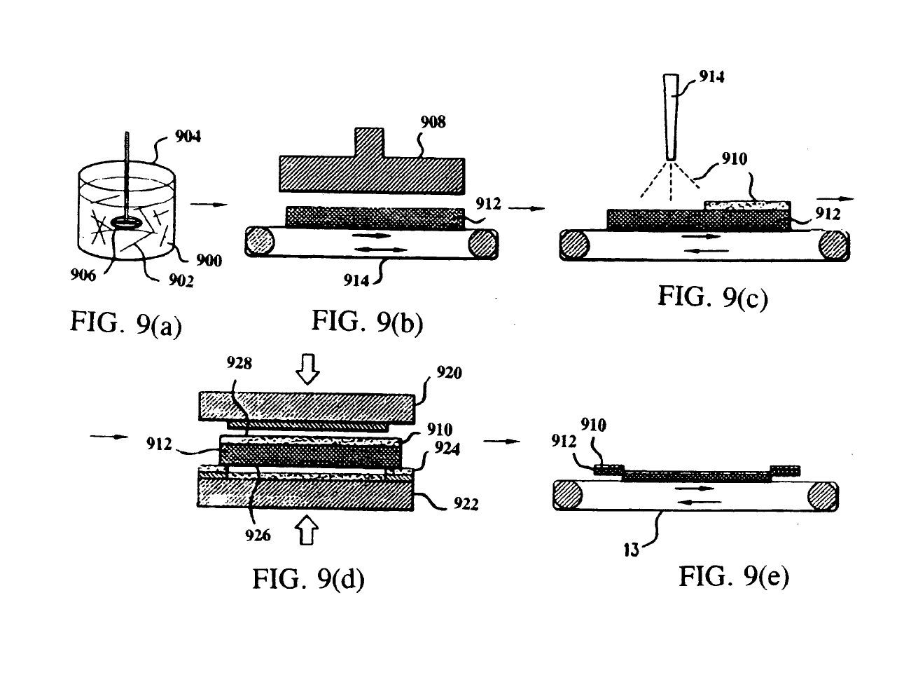

Thus, in an embodiment (FIG. 9), the present invention describes a method for making a thin-layer wood composite having increased water resistance comprising forming a wood composite mixture 900 comprising: (i) a refined wood fiber 902 having a predefined moisture content of about 3% to about 15%; (ii) optionally, about 0.1 to about 2.0% wax; (iii) greater than 5% by weight of an organic isocyanate resin; and (iv) optionally, at least 1% by weight of an internal release agent (FIG. 9(a)). The mixture may be prepared in bulk using standard blowline blending of the resin and fibers. Or, blenders 904 having a means for mixing 906 such as a paddle or the like, may be used.

Next, the wood composite mixture may be formed into a loose mat in a forming box. The mat 912 is then pre-shaped using a shave-off roller (not shown in FIG. 9) and pre-compressed using a roller or some other type of press 908 (FIG. 9(b)). The specific density of the mat may vary depending on the nature of the wood composite being formed, but generally, the mat is formed to have a density of about 6 to 8 pounds per cubic foot (i.e., 96.2-128.1 kg per cubic meter). After further trimming of the mat to the correct size and shape, at least one surface of the mat may be exposed to additional release agent 910 by spraying the release agent onto the surface of the mat 912 using a spray nozzle 914 (FIG. 9(c)). Also, shown in FIG. 9 are conveyors 914 and 916 as a means for transferring the wood composite from one station to another. It is understood that other means of supporting or transferring the thin-layer wood composite from one station to another, or supporting the composite during the processing steps may be used.

The mat 912 may then be placed between a male die 920 and a female die 922, and pressed at an elevated temperature and pressure and for a sufficient time as discussed above to further reduce the thickness of the thin-layer composite and to allow the isocyanate resin to interact with the wood fibers (FIG. 9(d)). As described above, it is believed that by heating the wood composite in the presence of the resin, the isocyanate of the resin forms a urethane linkage with the hydroxyl groups of the wood cellulose. Replacement of the hydroxyl groups of the cellulose with the urethane linkage prevents water from hydrating or being lost from with the cellulose hydroxyl groups. Thus, once the resin has cured, a doorskin having a predetermined resistance to moisture is formed. As described above, in an embodiment, one of the dies may be coated with an anti-bonding agent. FIG. 9 shows an embodiment in which the female die 922 is coated on its inner surface with an anti-bonding agent 924.

In alternative embodiments, both dies (920 and 922) are coated with anti-bonding agent. For example, this embodiment may be preferred where both die surfaces do not have a grain pattern, but are smooth. Or, in an embodiment, both inner die surfaces may be coated with an anti-bonding agent, and the use of release agent to coat the mat may vary depending upon the particular wood composite being prepared. Or, in an embodiment, the method may employ release agent on the surface of the mat, without coating of the dies. In yet another embodiment, the method may employ an internal release agent in the mat, without coating of the dies.

Subsequently, the doorskin is allowed to cool (FIG. 9(e)) and then further processed (sizing and priming) prior to being applied to a doorframe.

Thus, the invention describes using a release agent and/or anti-bonding agent to prevent the thin-layer wood composite from sticking to the pressing dies during production. In this way, resin levels as high as 15% may be used to form doorskins that are only a few millimeters thick (e.g., about 3 mm), without the composite sticking to the dies during pressing.

The release agent and/or anti-bonding agent used to prevent the mat from sticking to the dies during production may be applied to the mat in various ways, as discussed above. Generally, when the mat is used to produce a standard doorskin, one of the dies comprises a recess and is described as the female die. Referring to FIG. 9, usually the female die 922 is positioned underneath the lower surface 926 of the mat 912, which is the surface of the mat that is adhered to the underlying door-frame (i.e., the inner surface). The other (upper) surface of the mat 928 corresponds to the side of the doorskin that will be on the outside of the door. Often, this side of the doorskin will include a grain texture to improve the decorative effect. The die 920 used to press the upper side of the mat (i.e. the eventual outside of the door) may be termed the male die. Thus, the male die includes a protruding portion that is the mirror image of the recess on the female die, and optionally, a grain-like pattern on the surface of the die. In one embodiment, an anti-bonding agent is coated onto the bottom (female) die. Depending on the actual anti-bonding agent used, the coating may be baked onto the bottom die. In this way, the coated die may be used several times before re-coating with additional anti-bonding agent. For example, in an embodiment, the step of baking the anti-bonding agent onto the die surface comprises: (i) cleaning the die surface free of any dirt, dust or grease; (ii) spraying about 0.003 inches (3 mils; 0726 mm) of a 50% solution of the anti-bonding agent onto the die; and (iii) baking the die at over 300° F. (149° C.) for about 1-4 hours. In an embodiment, the step of cleaning the die comprises cleaning the die surface with a degreaser; wire brushing to remove solids; wiping the die surface with a solvent (such as acetone); and buffing with a cotton pad. The anti-bonding agent is then applied to provide a 3 mil thickness; and the dies heated to bake the coating onto the die.

Under suitable conditions, the anti-bonding agent that is baked onto the die (or dies) is stable enough to the pressing conditions such that the die(s) can be used for over 2000 pressing cycles prior to requiring a second coating with additional anti-bonding agent. Anti-bonding agents that are suitable for baking onto the die surface include 7000 W (Chemtrend, Howell, Mich.), CrystalCoat MP-313 and Silvue (SDC Coatings, Anaheim, Calif.), ISO-Strip-23 Release Coating (ICI Polyurethanes, West Deptford, N.J.), aminoethlyaminopropyltrimethoxysilane (Dow Corning Corporation), or the like.

Although a preferred method to facilitate removal of the doorskin from the die uses a die coated with anti-bonding agent, other equivalent methods to facilitate non-sticking of the wood composite to the die may be incorporated into the methods of the present invention. For example, to facilitate release of the doorskin, the die(s) may be nickel plated, covered with a ceramic layer, or coated with fluorocarbons.

As described above, a release agent may be sprayed onto one of the surfaces of the pre-pressed mat prior to the mat being pressed between the dies. For example, and referring again to FIG. 9, a release agent 910 may be sprayed onto the upper surface 928 of the mat 912 which is exposed to the male die 920. Preferably, the release agent 910 sprayed directly onto the surface of the mat is a release agent 912 that is compatible with the wood and resin making up the composite and will not interfere with subsequent processing of the composite. Preferably, the release agent sprayed on the wood comprises compounds such as 8105W, 8107W, CS1093A (Chemtrend, Howell, Mich.), PAT®-7299/D2, PAT®-1667 (Wurtz GmbH & Co., Germany), and the like.

The amount of release agent sprayed onto at least one side of the mat may range from 0.1 to 8.0 grams solids per square foot (1.1 to 86.1 grams per square meter) of mat. For example, the release agent may be sprayed onto the mat as a 25% aqueous solution. In an embodiment, the amount of release agent sprayed on to at least one side of the mat may comprise about 4 grams solids per square foot (i.e., 43.05 grams per square meter) of mat sprayed as a 25% aqueous solution.

Alternatively, the release agent may be added directly to the mixture used to form the wood composite. In this embodiment, the release agent comprises up to about 1 to 8% by weight of the composite. For example, the release agent may be added as a solution (typically about 25% to 50% solids) and blended with the wood fiber, resin and optional wax. This approach has the advantage of not requiring equipment to spray the release agent onto the mat. Adding the release agent as part of the wood composite may require the use of more release agent than when only the surface of the composite is exposed. In some cases (e.g., low production runs) the cost of the extra materials is justified since the production set up is simplified.

As described herein, the present invention describes the use of isocyanate resins to prepare wood composites, One of the advantages of using isocyanate resins rather than formaldehyde crosslinked resins is that less energy is needed to dry the wood fiber prior to pressing the mat. As described herein, traditional phenol-formaldehyde resins are not compatible with wood having a water content much greater than 8%, as the water tends to interfere with the curing process. Also, excess moisture in the wood fiber can cause blistering when pressed with melamine formaldehyde resins or urea-formaldehyde resins. Thus, for wood having a moisture content of greater than 8%, the wood must be dried for the curing step, and then re-hydrated later. In contrast, isocyanate-based resins are compatible with wood having a higher water content and thus, curing with isocyanate-based resins may obviate the need for the drying and the re-hydrating steps associated with formaldehyde-based resins.

To prepare a wood composite that is resistant to water, the concentration of the isocyanate resin should be at least about 5%, may be on the order of about 6-8%.

In an embodiment, the press time and temperature may vary depending upon the resin used. For example, using a toluene diisocyanate (TDI) resin as opposed to diphenylmethane diisocyanate (MDI) resin may shorten the press time by as much as 10%. Generally, when using isocyanate resins, very high temperatures are not required; thus, isocyanate resins are associated with decreased energy costs and less wear on the boiler. Still, composites made at very low temperatures do not display sufficient resistance to moisture to be commercially useful. Thus, the temperature used for pressing may range from 250° F. to 400° F. (121° C. to 204° C.), or more preferably, between 280° F. and 350° F. (138° C. to 177° C.). In an embodiment, ranges between 310° F. (154° C.) to about 330° F. (166° C.) are preferred.

The pressure used during pressing maybe constant, or varied in a step-wise fashion. Depending upon the selected temperature and pressure conditions used for pressing, the total pressing may range from 30 seconds to 5 minutes or more. Thus, the pressure during the pressing step may include ranges from about 2500 psi (176 kg/cm²) to about 150 psi (10.5 kg/cm²). Or, the pressure may be applied in a step-wise manner. For example, the pressure during the pressing step may range from about 1200 psi (84.3 kg/cm²) to about 2500 psi (176 kg/cm²) for about 5 to 20 seconds followed by 500 psi (35.16 kg/cm²) for 20 to 80 seconds. In one embodiment, the pressure during the pressure step ranges from about 1200 psi (84.3 kg/cm²) for about 10 seconds to about 500 psi (35.16 kg/cm²) for about 50 seconds.

The present invention also encompasses wood products comprising wood composites made by the method of the invention. For example, in one aspect, the present invention comprises a wood composite a mixture of: (a) no more than 95% by weight of a wood fiber, wherein the wood fiber has a predetermined moisture content of at least about 3%; (b) at least 5% by weight of an organic isocyanate resin; (c) optionally, at least 0.5% by weight of a wax; (d) optionally, at least 1% by weight of an internal release agent; and (e) optionally, at least 0.2 grams release agent per square foot (2.15 grams per square meter) as applied to the surface of the composite.

Preferably, wood composites made by the method of the invention comprise significantly less linear expansion and swelling than wood composites made by conventional methods. Thus, doorskins made by the method of the present invention exhibit 50% less linear expansion and thickness swelling than composite doorskins made with formaldehyde-based resins of the same content (such as, for example, 6% melamine-urea-formaldehyde doorskins) when boiled in water for 2 hours. Also, doorskins made by the present invention exhibit 50% less linear expansion than non-isocyanate based doorskins when immersed in water for 24 hours at 70° F. (21.1° C.), a standard test used in the industry (ASTM D1037).

As described above, the thin-layer lignocellulosic composites of the present invention comprise a predetermined thickness, such that the resultant composite comprises a flat planar structure. In an embodiment, the predetermined thickness ranges from 0.100 inches to 0.5 inches (2.54 mm to 13 mm). In an alternate embodiment, the predetermined thickness of the thin-layer composite may range from 0.090 to 0.385 inches (2.28 to 9.78 mm).

Also in an embodiment, doorskins made by the methods of the present invention are significantly less dense than doorskins made using traditional formaldehyde-based resins. For a doorskin that is 0.12 inches (3.05 mm) thick and has 10% melamine-urea-formaldehyde resin and 1.5% wax, the density is about 58 pounds per cubic foot (930 kg/m³). In contrast, doorskins of the present invention (6% MDI resin; 0.5% release agent) may have a density as low as 50 pounds per cubic foot (801 kg/m³).

### EXAMPLE

Various parameters that would be expected to improve the stability of doorskins to water were tested, including altering the moisture content and other attributes of the wood fiber, altering the amount and type of the resin, and altering the press conditions (temperature, pressure and/or time). Ultimately, it was found that isocyanate-based resin binders provided a wood composite that is resistant to water when resin levels of about 6% and up to about 15% were employed. However, when resin at these levels of resin was used, the resulting composite tended to stick to the pressing dies during manufacture. For example, in a sample run using 10% MDI, about 1.5% wax, and 88.5% wood fiber at 10% moisture content, pressed at a temperature of 320° F. (160° C.) and using pressing cycles as described herein, it was found that after 6 to 8 press loads the wood composite would stick to the pressing dies.

Various methods were tried to prevent the door-skins from sticking to the dies. It was determined that the addition of a release agent to the surface of the pre-pressed mat used to make the doorskin allowed the doorskin to be removed from the male die. In additional experiments, the release agent was added directly to the composite mixture. For effective release, approximately 0.5 to 8% by weight of the release agent was required. It was found that for consistent results, about 0.6 to 3% internal release agent was preferred.

As the release agent is theoretically only required at the surface, methods to treat the surface of the doorskin were evaluated. It was found that spraying the surface of the mat with a 25% solution of PAT®-7299/D2 (Wurtz GmbH & Co., Germany) provided sufficient release agent to successfully remove the doorskin from the male die. It was further found that concentrations of release agent ranging from 0.1 to 8 grams solid per square foot (1.1 to 86.1 grams per square meter) of mat were effective (generally administered as a 25% solution). However, about 2-4 grams release agent solids per square foot (2.2 to 43.05 grams per square meter) of mat was found to provide consistent results, with higher concentrations providing only minimally better results.

Methods were evaluated to apply a release agent to the underside of the mat and the top surface of the bottom die for each press load. It was found, however, that treating the surface of the bottom die with an anti-bonding agent may be preferable for eliminating bonding of the mat to the bottom die. An anti-bonding agent, such as 7000W (Chemtrend) was used to coat the surface of the female die. Initial experiments used excess anti-bonding agent to flood the surface of the die. Further testing indicated that baking the anti-bonding agent onto the surface of the female (bottom) die allowed for the die to be used multiple times prior to being retreated. To bake the anti-bonding agent onto the die, the female die was treated by (i) cleaning the surface of the die free of dust, dirt and grease using a degreaser, wire brush treatment and solvent; (ii) spraying about 0.003 inches (3 mils; 0.0762 mm) of a 50% solution of the release agent onto the die; and (iii) baking the die at a temperature of about 300° F. (149° C.) to 350° F. (177° C.) for about 1-4 hours.

Thus, it was found that addition of 2-4 g per square foot of a release agent to the upper surface of the pre-pressed mat, and baking the anti-bonding agent 7000W (Chemtrend) onto the female (bottom) die allowed for easy removal of the doorskins having 6% or more MDI resin from both dies easily. Additionally, it was determined that over 2000 press loads could be made prior to recoating the female die with additional anti-bonding agent.

The wood composites made by the method of the invention showed significantly less linear expansion and swelling than wood composites made by conventional methods. Thus, doorskins made by the method of the present invention exhibited 50% less linear expansion and thickness swelling than composite doorskins made with formaldehyde-based resins of the same content (e.g., 6% melamine-urea-formaldehyde doorskins) when boiled in water for 2 hours. Also, doorskins made by the present invention exhibited 50% less linear expansion than comparable formaldehyde-based doorskins than non-isocyanate based doorskins when immersed in water for 24 hours at 70° F. (21.1° C.), a standard test used in the industry (ASTM D1037).

Also, doorskins made by the methods of the present invention were found to be significantly less dense than doorskins made using traditional formaldehyde-based resins. For example, a doorskin that is 0.12 inches (3.05 mm) thick and has 6% melamine-urea-formaldehyde resin and 1.5% wax has a density of about 58 pounds per cubic foot (930 kg/m3). In contrast, doorskins of the present invention (6% MDI resin; 0.5% wax) were found to have a density as low as 50 pounds per cubic foot (801 kg/m³).

It will be recognized by those having ordinary skill in the art that the present methods and compositions disclosed here include:

1. Preparation of thin-layer lignocellulosic composites, such as exterior doorskins, that have increased resistance to moisture-induced shrinking and/or swelling;

2. Reduced energy costs for preparation of thin-layer lignocellulosic composites, such as door-skins, in that pre-drying of the wood is reduced significantly;

3. A method adaptable to high-throughput production in that multiple doorskins may be pressed without re-coating of the pressing dies;

4. Use of isocyanate-based resins at concentrations which provide high water-resistance in a thin-layer lignocellulosic wood composite; and

5. Reduced cost of the thin-layer lignocellulosic composite as additional treatments to impart moisture-resistance are not required.

It will be understood that each of the elements described above, or two or more together, may also find utility in applications differing from the types described. While the invention has been illustrated and described as a method for high-throughput preparation of thin-layer lignocellulosic composites, such as doorskins, it is not intended to be limited to the details shown, since various modifications and substitutions can be made without departing in any way from the spirit and scope of the present invention. As such, further modifications and equivalents of the invention herein disclosed may occur to persons skilled in the art using no more than routine experimentation, and all such modifications and equivalents are believed to be within the spirit and scope of the invention as described herein.

We Claim:

1. A method to produce a thin-layer lignocellulosic composite having increased resistance to moisture-induced shrinking or swelling comprising:
a. forming a lignocellulosic composite mixture comprising (1) at least one type of lignocellulosic fiber having a moisture content of at least about 3% by weight and (2) at least 5% by weight of an organic isocyanate resin, a release agent that does not interfere with subsequent processing of the thin-layer lignocellulosic composite, and, optionally, at least one type of wax;
b. pre-pressing the mixture into a loose mat; and
c. pressing the mat between two dies at an elevated temperature and pressure and for a sufficient time to further reduce the thickness of the mat to form a thin-layer composite having a thickness of between about 1 and about 13 mm, and to allow the isocyanate resin to interact with the lignocellulosic fiber such that the resultant thin-layer composite has a predetermined resistance to moisture, wherein the thin-layer lignocellulosic composite comprises a flush or molded door skin suitable for exterior use, and wherein at least one surface of at least one die is coated with an anti-bonding agent.

2. The method according to claim 1, wherein the lignocellulosic fiber comprises wood.

3. The method according to claim 1, wherein the wax is selected from the group consisting of paraffin wax, polyethylene wax, polyoxyethylene wax, microcrystalline wax, shellac wax, ozokerite wax, montan wax, emulsified wax, slack wax, and combinations thereof.

4. The method according to claim 1, wherein the mixture comprises up to about 2% by weight wax.

5. The method according to claim 1, wherein the release agent is an internal release agent.

6. The method according to claim 5, wherein the release agent comprises an emulsion of surfactants and polymers.

7. The method according to claim 7, wherein the release agent is present in an amount of between about 0.1% and about 3% by weight.

8. The method according to claim 1, wherein the mixture further comprises fiberglass.

9. The method according to claim 9, wherein the mixture comprises between about 1% and about 15% by weight fiberglass.

10. The method according to claim 5, wherein the release agent is added directly to the fiber prior to forming the mixture into a loose mat.

11. The method according to claim 1, wherein the anti-bonding agent is selected from the group consisting of silane, silicone, siloxane, fatty acids, polycarboxyl compounds and combinations thereof.

12. The method according to claim 1, wherein each die is coated with the anti-bonding agent.

13. The method according to claim 12, wherein the step of coating each die with an anti-bonding agent comprises baking the anti-bonding agent onto the die surface.

14. The method according to claim 1, further comprising spraying additional release agent onto at least one surface of the loose mat.

15. The method according to claim 14, wherein only one die is coated with the anti-bonding agent and the release agent is sprayed onto the surface of the loose mat opposite the surface to be brought into contact with the coated die.

16. The method according to claim 1, wherein the lignocellulosic mixture comprises between about 80 to about 95% by weight fiber.

17. The method according to claim 1, wherein the moisture content of the lignocellulosic fiber after drying is between about 4% and about 20% moisture content by weight.

18. The method according to claim 1, wherein the isocyanate is selected from the group consisting of diphenylmethane diisocyanate (MDI), toluene diisocyanate (TDI), and combinations thereof.

19. The method according to claim 1, wherein the mixture comprises from about 2 to about 15% by weight resin solids.

20. The method according to claim 1, wherein the mixture comprises about 6 to about 8% by weight resin solids.

21. The method according to claim 1, wherein the temperature used to press the mat is between about 275° F. and about 375° F.

22. The method according to claim 1, wherein the pressure used to press the mat into a thin layer ranges from about 2500 psi (176 kg/cm²) to about 150 psi (10.5 kg/cm²).

23. The method according to claim 1, wherein the pressure used to press the mat into a think layer ranges from about 1200 psi (84.3 kg/cm²) for about 5 to about 20 seconds followed by about 500 psi (35.16 kg/cm²) for about 10 to about 80 seconds.

24. The method according to claim 1, wherein the thin-layer composite exhibits up to 50% less linear expansion and thickness swelling after being immersed for 24 hours in 70° F. (21° C.) water than thin-layer composites comprising a non-isocyanate based resin, such as urea formaldehyde.

25. A thin-layer lignocellulosic comprising a mixture of no more than 95% by weight of at least one type of lignocellulosic fiber having a moisture content of at least about 3% by weight, at least 5% by weight of an organic isocyanate resin, an internal release agent, and, optionally, a wax distinct from the internal release agent, wherein the mixture is pressed between two dies at an elevated temperature and pressure and for a sufficient time to form a thin-layer composite of predetermined thickness, and to allow the isocyanate resin to interact with the lignocellulosic fiber such that the resultant thin-layer composite has a predetermined resistance to moisture.

26. The thin-layer lignocellulosic composite according to claim 25, wherein the lignocellulosic fiber comprises wood.

27. The thin-layer lignocellulosic composite according to claim 25, wherein the wax is selected from one or more of paraffin wax, polyethylene wax, polyoxyethylene wax, microcrystalline wax, shellac wax, ozokerite wax, montan wax, emulsified wax, slack wax, and combinations thereof.

28. The thin-layer lignocellulosic composite according to claim 25, wherein the mixture comprises up to about 2% by weight of wax.

29. The thin-layer lignocellulosic composite according to claim 25, wherein the release agent comprises an emulsion of surfactants and polymers.

30. The thin-layer lignocellulosic composite according to claim 25, wherein additional moisture is sprayed onto the mat before the mixture is pressed.

31. The thin-layer lignocellulosic composite according to claim 25, wherein the amount of release agent is between about 0.3% to about 3%.

32. The thin-layer lignocellulosic composite according to claim 25, wherein the lignocellulosic fiber ranges from about 80% to about 95% by weight.

33. The thin-layer lignocellulosic composite according to claim 25, wherein the moisture content of the fiber ranges from about 4% to about 20% by weight after drying.

34. The thin-layer lignocellulosic composite according to claim 25, wherein the isocyanate comprises diphenylmethane diisocyanate, toluene diisocyanate, and combinations thereof.

35. The thin-layer lignocellulosic composite according to claim 34, wherein the isocyanate comprises diphenylmethane-4,4′-diisocyanate.

36. The thin-layer lignocellulosic composite according to claim 25, wherein the mixture comprises between about 5% and about 15% by weight resin.

37. The thin-layer lignocellulosic composite according to claim 25, wherein the predetermined resistance to moisture comprises up to a 50% reduction in linear expansion and thickness swelling after being immersed 24 hours in 70° F. (21° C.) water than a thin-layer composite comprising a resin that does not include isocyanate, such as urea formaldehyde.

38. The thin-layer lignocellulosic composite according to claim 25, wherein the mixture further includes fiberglass.

39. The thin-layer lignocellulosic composite according to claim 38, wherein the fiberglass is present in an amount between about 2% and about 10% by weight of the mixture.

40. The thin-layer lignocellulosic composite according to claim 25, wherein the predetermined thickness ranges from about 0.086 inches (2.16 mm) to about 0.512 inches (13 mm).

41. The thin-layer lignocellulosic composite according to claim 25, further comprising a density of less than about 60 pounds per cubic foot (962 kg/m³).

42. The thin-layer lignocellulosic composite according to claim 25, further comprising a region of increased thickness to provide at least one raised surface, such that the raised surface comprises the appearance of at least one of wooden planking or wooden trim.

43. The thin-layer lignocellulosic composite according to claim 25, wherein the composite comprises a panel for a garage door.

44. A garage door panel comprising a panel having a region of increased thickness to provide at least one raised surface, such that the raised surface comprises the appearance of at least one of wooden planking or wooden trim, the panel further comprising a mixture of no more than 95% by weight of at least one type of lignocellulosic fiber having a moisture content of at least about 3% by weight, at least 5% by weight of an organic isocyanate resin, an internal release agent, and, optionally, a wax that is distinct from the internal release agent wherein the mixture is pressed between two dies at an elevated temperature and pressure and for a sufficient time to form a thin-layer composite of predetermined thickness, and to allow the isocyanate resin to interact with the lignocellulosic fiber such that the resultant thin-layer composite has a predetermined resistance to moisture; a frame comprising at least two vertical stiles and two horizontal rails; a core material emplaced within, and bounded by, the frame.

45. The garage door panel of claim 44, further comprising a second thin-layer composite comprising a second face of the door panel.
